(19) United States
(12) Patent Application Publication
(10) Pub. No.: US 2023/0180188 A1
(43) Pub. Date: Jun. 8, 2023

(54) FREQUENCY MULTIPLEXING FOR SIDELINK TRANSMISSIONS

(71) Applicant: QUALCOMM Incorporated, San Diego, CA (US)

(72) Inventors: Shuanshuan WU, San Diego, CA (US); Arthur GUBESKYS, San Diego, CA (US); Shailesh PATIL, San Diego, CA (US); Gene Wesley MARSH, San Diego, CA (US); Stelios STEFANATOS, San Diego, CA (US)

(21) Appl. No.: 17/997,358

(22) PCT Filed: May 27, 2021
(86) PCT No.: PCT/US2021/034457

§ 371 Date: Oct. 27, 2022

(30) Foreign Application Priority Data
Jun. 24, 2020 (GR) 20200100361

(51) Int. Cl. H04W 72/02; H04W 72/0453; H04W 74/08

(52) U.S. Cl. CPC H04W 72/02; H04W 72/0453; H04W 74/0816

(57) ABSTRACT

Methods, systems, and devices for wireless communications are described to reduce interference caused by power leakage. A first user equipment (UE) or a base station may select communication resources for a sidelink communication based on a distance between UEs reserving frequency resources in a same time window. The first UE or the base station may determine a distance parameter between the first UE and one or more other UEs (e.g., including a second UE) reserving frequency resources within the time window. The distance parameter may represent a physical distance between the first and second UEs or a reference signal received power of the second UE as received by the first UE. The first UE or the base station may select communication resources based on whether the distance parameter is below a threshold, and the first UE may communicate the sidelink communication using the selected resources.

### CROSS REFERENCE

The present Application is a 371 national stage filing of International PCT Application No. PCT/US2021/034457 by WU et al. entitled “FREQUENCY MULTIPLEXING FOR SIDELINK TRANSMISSIONS,” filed May 27, 2021; and claims priority to Greece Provisional Patent Application No. 20200100361 by WU et al., entitled “FREQUENCY MULTIPLEXING FOR SIDELINK TRANSMISSIONS,” filed Jun. 24, 2020, each of which is assigned to the assignee hereof, and each of which is expressly incorporated by reference in its entirety herein.

### FIELD OF TECHNOLOGY

The following relates generally to wireless communications and more specifically to frequency multiplexing for sidelink transmissions.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

Some communications between UEs, such as sidelink communications, may result in interference at other UEs, which may decrease communication quality and reliability at the other UEs.

### SUMMARY

The described techniques relate to improved methods, systems, devices, and apparatuses that support frequency multiplexing for sidelink transmissions. Generally, the described techniques provide for reducing interference caused by power leakage. A first user equipment (UE) or a base station may select communication resources for a sidelink communication based on a distance between UEs reserving frequency resources in a same time window (e.g., transmission time interval (TTI) or channel occupancy time (COT)). For example, the first UE may select resources or receive allocated resources (e.g., from the base station) for transmitting the sidelink communication to a second UE. When frequency resources are reserved for the sidelink communication (e.g., by the first UE or the base station) within a time window, the first UE or the base station may determine a distance parameter between the first UE and one or more other UEs (e.g., including a third UE) reserving frequency resources within the time window. The distance parameter may represent a physical distance between the first UE and the one or more UEs, for example, based on broadcasted sidelink information that may include location information. Additionally or alternatively, the distance parameter may be represented by a reference signal received power (RSRP) of the one or more UEs as measured by the first UE.

If the distance parameter is less than a threshold (e.g., the first and third UEs are in a similar location or sufficiently close to each other), the first UE or the base station may select frequency resources within the time window. If the distance parameter is greater than the threshold, the first UE or the base station may select frequency resources based on one or more restrictions. For example, the first UE or the base station may select frequency resources within a different time window or may select frequency resources at an offset from frequency resources reserved by the one or more UEs. Doing so may, for example, reduce general power leakage interference because the first UE may transmit the sidelink communication within a time window or within frequency resources with reduced interference from power leakage. If the base station selects the resources based on the distance parameter, the base station may allocate the resources to the first UE via a control message. The first UE may use the selected resources (e.g., selected by the first UE or the base station) to transmit the sidelink communication to the second UE.

A method of wireless communications at a first UE is described. The method may include identifying a distance parameter associated with the first UE and a second UE, determining whether the distance parameter is less than a threshold, performing, within a time window that includes a communication resource allocated to the second UE and based on determining whether the distance parameter is less than the threshold, a selection process for a frequency resource for a frequency multiplexed sidelink communication, and transmitting the frequency multiplexed sidelink communication based on the selection process.

An apparatus for wireless communications at a first UE is described. The apparatus may include a processor, memory coupled with the processor, and instructions stored in the memory. The instructions may be executable by the processor to cause the apparatus to identify a distance parameter associated with the first UE and a second UE, determine whether the distance parameter is less than a threshold, perform, within a time window that includes a communication resource allocated to the second UE and based on determining whether the distance parameter is less than the threshold, a selection process for a frequency resource for a frequency multiplexed sidelink communication, and transmit the frequency multiplexed sidelink communication based on the selection process.

Another apparatus for wireless communications at a first UE is described. The apparatus may include means for identifying a distance parameter associated with the first UE and a second UE, determining whether the distance parameter is less than a threshold, performing, within a time window that includes a communication resource allocated to the second UE and based on determining whether the distance parameter is less than the threshold, a selection process for a frequency resource for a frequency multiplexed sidelink communication, and transmitting the frequency multiplexed sidelink communication based on the selection process.

A non-transitory computer-readable medium storing code for wireless communications at a first UE is described. The code may include instructions executable by a processor to identify a distance parameter associated with the first UE and a second UE, determine whether the distance parameter is less than a threshold, perform, within a time window that includes a communication resource allocated to the second UE and based on determining whether the distance parameter is less than the threshold, a selection process for a frequency resource for a frequency multiplexed sidelink communication, and transmit the frequency multiplexed sidelink communication based on the selection process.

Some examples of the method, apparatuses, and non-transitory computer-readable medium described herein may further include operations, features, means, or instructions for determining that the distance parameter may be less than the threshold, and selecting the frequency resource for the frequency multiplexed sidelink communication within the time window based on the distance parameter being less than the threshold.

Some examples of the method, apparatuses, and non-transitory computer-readable medium described herein may further include operations, features, means, or instructions for determining that the distance parameter may be greater than the threshold, identifying a restriction for the frequency resource for the frequency multiplexed sidelink communication based on the distance parameter being greater than the threshold, and selecting the frequency resource for the frequency multiplexed sidelink communication based on the restriction.

In some examples of the method, apparatuses, and non-transitory computer-readable medium described herein, selecting the frequency resource may include operations, features, means, or instructions for excluding, based on the restriction, frequency resources within the time window from candidate resources for selecting the frequency resource.

In some examples of the method, apparatuses, and non-transitory computer-readable medium described herein, selecting the frequency resource may include operations, features, means, or instructions for selecting, based on the restriction, the frequency resource for the frequency multiplexed sidelink communication within the time window and offset in frequency from the communication resource allocated to the second UE.

Some examples of the method, apparatuses, and non-transitory computer-readable medium described herein may further include operations, features, means, or instructions for receiving configuration signaling indicating the offset in frequency.

Some examples of the method, apparatuses, and non-transitory computer-readable medium described herein may further include operations, features, means, or instructions for determining the distance parameter based on measuring an RSRP from the second UE, where the distance parameter and the threshold include respective RSRPs.

In some examples of the method, apparatuses, and non-transitory computer-readable medium described herein, a set of UEs including the second UE may be allocated respective communication resources within the time window, and the second UE may have a smallest RSRP relative to the first UE out of the set of UEs.

Some examples of the method, apparatuses, and non-transitory computer-readable medium described herein may further include operations, features, means, or instructions for determining the distance parameter based on a location of the first UE and an indication of a location of the second UE, where the distance parameter and the threshold include respective distances.

In some examples of the method, apparatuses, and non-transitory computer-readable medium described herein, a set of UEs including the second UE may be allocated respective communication resources within the time window, and the second UE may have a largest distance from the first UE out of the set of UEs.

In some examples of the method, apparatuses, and non-transitory computer-readable medium described herein, a set of UEs including the second UE may be allocated respective communication resources within the time window, and the second UE initiates a COT used by the first UE and the second UE.

Some examples of the method, apparatuses, and non-transitory computer-readable medium described herein may further include operations, features, means, or instructions for determining the distance parameter based on a location of the first UE and a location of a COT used by the second UE, where the distance parameter and the threshold include respective distances.

In some examples of the method, apparatuses, and non-transitory computer-readable medium described herein, the location of the COT includes a location of a wireless device that initiates the COT.

In some examples of the method, apparatuses, and non-transitory computer-readable medium described herein, the location of the COT includes a geographic location or geographic zone associated with the COT.

In some examples of the method, apparatuses, and non-transitory computer-readable medium described herein, determining whether the distance parameter may be less than the threshold may include operations, features, means, or instructions for determining that the distance parameter may be less than the threshold based on a zone identifier (ID) associated with the first UE being a same zone ID associated with the COT.

In some examples of the method, apparatuses, and non-transitory computer-readable medium described herein, the location of the COT may be received via COT sharing information or may be configured for the COT.

Some examples of the method, apparatuses, and non-transitory computer-readable medium described herein may further include operations, features, means, or instructions for receiving configuration signaling indicating the threshold.

A method of wireless communications at a base station is described. The method may include identifying a distance parameter associated with a first UE and a second UE, determining whether the distance parameter is less than a threshold, performing, within a time window that includes a communication associated with the second UE and based on determining whether the distance parameter is less than the threshold, a selection process for a frequency resource for a frequency multiplexed sidelink communication for the first UE, and allocating resources to the first UE for the frequency multiplexed sidelink communication based on the selection process.

An apparatus for wireless communications at a base station is described. The apparatus may include a processor, memory coupled with the processor, and instructions stored in the memory. The instructions may be executable by the processor to cause the apparatus to identify a distance parameter associated with a first UE and a second UE, determine whether the distance parameter is less than a threshold, perform, within a time window that includes a communication associated with the second UE and based on determining whether the distance parameter is less than the threshold, a selection process for a frequency resource for a frequency multiplexed sidelink communication for the first UE, and allocate resources to the first UE for the frequency multiplexed sidelink communication based on the selection process.

Another apparatus for wireless communications at a base station is described. The apparatus may include means for identifying a distance parameter associated with a first UE and a second UE, determining whether the distance parameter is less than a threshold, performing, within a time window that includes a communication associated with the second UE and based on determining whether the distance parameter is less than the threshold, a selection process for a frequency resource for a frequency multiplexed sidelink communication for the first UE, and allocating resources to the first UE for the frequency multiplexed sidelink communication based on the selection process.

A non-transitory computer-readable medium storing code for wireless communications at a base station is described. The code may include instructions executable by a processor to identify a distance parameter associated with a first UE and a second UE, determine whether a distance parameter is less than a threshold, perform, within a time window that includes a communication associated with the second UE and based on determining whether the distance parameter is less than the threshold, a selection process for a frequency resource for a frequency multiplexed sidelink communication for the first UE, and allocate resources to the first UE for the frequency multiplexed sidelink communication based on the selection process.

Some examples of the method, apparatuses, and non-transitory computer-readable medium described herein may further include operations, features, means, or instructions for determining that the distance parameter may be less than the threshold, and allocating the frequency resource for the frequency multiplexed sidelink communication within the time window based on the distance parameter being less than the threshold.

Some examples of the method, apparatuses, and non-transitory computer-readable medium described herein may further include operations, features, means, or instructions for determining that the distance parameter may be greater than the threshold, identifying a restriction for the frequency resource for the frequency multiplexed sidelink communication based on the distance parameter being greater than the threshold, and allocating the frequency resource for the frequency multiplexed sidelink communication based on the restriction.

In some examples of the method, apparatuses, and non-transitory computer-readable medium described herein, allocating the frequency resource may include operations, features, means, or instructions for allocating, based on the restriction, the frequency resource for the frequency multiplexed sidelink communication within a second time window different than the time window.

In some examples of the method, apparatuses, and non-transitory computer-readable medium described herein, allocating the frequency resource may include operations, features, means, or instructions for allocating, based on the restriction, the frequency resource for the frequency multiplexed sidelink communication within the time window and offset in frequency from the communication resource allocated to the second UE.

Some examples of the method, apparatuses, and non-transitory computer-readable medium described herein may further include operations, features, means, or instructions for communicating configuration signaling indicating the offset in frequency.

Some examples of the method, apparatuses, and non-transitory computer-readable medium described herein may further include operations, features, means, or instructions for determining the distance parameter based on receiving an indication, from the first UE, of an RSRP of the second UE, where the distance parameter and the threshold include respective RSRPs.

Some examples of the method, apparatuses, and non-transitory computer-readable medium described herein may further include operations, features, means, or instructions for transmitting, to the first UE and the second UE, an indication to report a measurement of an RSRP for determining the distance parameter.

In some examples of the method, apparatuses, and non-transitory computer-readable medium described herein, a set of UEs including the second UE may be allocated respective communication resources within the time window, and the second UE may have a smallest RSRP relative to the first UE out of the set of UEs.

Some examples of the method, apparatuses, and non-transitory computer-readable medium described herein may further include operations, features, means, or instructions for determining the distance parameter based on receiving an indication of a location of the first UE and an indication of a location of the second UE, where the distance parameter and the threshold include respective distances.

Some examples of the method, apparatuses, and non-transitory computer-readable medium described herein may further include operations, features, means, or instructions for transmitting, to the first UE and the second UE, an indication to report a measurement of a location for determining the distance parameter.

In some examples of the method, apparatuses, and non-transitory computer-readable medium described herein, a set of UEs including the second UE may be allocated respective communication resources within the time window, and the second UE may have a largest distance from the first UE out of the set of UEs.

In some examples of the method, apparatuses, and non-transitory computer-readable medium described herein, a set of UEs including the second UE may be allocated respective communication resources within the time window, and the second UE initiates a COT used by the first UE and the second UE.

Some examples of the method, apparatuses, and non-transitory computer-readable medium described herein may further include operations, features, means, or instructions for receiving the distance parameter from the first UE based on a location or an RSRP of the second UE determined by the first UE.

### BRIEF DESCRIPTION OF THE DRAWINGS

FIG. 1 illustrates an example of a wireless communications system that supports frequency multiplexing for sidelink transmissions in accordance with aspects of the present disclosure.

FIG. 2 illustrates an example of a wireless communications system that supports frequency multiplexing for sidelink transmissions in accordance with aspects of the present disclosure.

FIGS. 3A and 3B illustrate respective examples of resource selection schemes that support frequency multiplexing for sidelink transmissions in accordance with aspects of the present disclosure.

FIG. 4 illustrates an example of a process flow that supports frequency multiplexing for sidelink transmissions in accordance with aspects of the present disclosure.

FIGS. 5 and 6 show block diagrams of devices that support frequency multiplexing for sidelink transmissions in accordance with aspects of the present disclosure.

FIG. 7 shows a block diagram of a communications manager that supports frequency multiplexing for sidelink transmissions in accordance with aspects of the present disclosure.

FIG. 8 shows a diagram of a system including a device that supports frequency multiplexing for sidelink transmissions in accordance with aspects of the present disclosure.

FIGS. 9 and 10 show block diagrams of devices that support frequency multiplexing for sidelink transmissions in accordance with aspects of the present disclosure.

FIG. 11 shows a block diagram of a communications manager that supports frequency multiplexing for sidelink transmissions in accordance with aspects of the present disclosure.

FIG. 12 shows a diagram of a system including a device that supports frequency multiplexing for sidelink transmissions in accordance with aspects of the present disclosure.

FIGS. 13 through 18 show flowcharts illustrating methods that support frequency multiplexing for sidelink transmissions in accordance with aspects of the present disclosure.

### DETAILED DESCRIPTION

Some user equipments (UEs) may communicate using sidelink communications. For example, a first UE and a second UE may communicate using sidelink communications, and a third UE may communicate with one or more other UEs using sidelink communications. Some resources allocated to the first and second UEs may be interlaced with resources allocated to the third UE, such that the resources allocated to the first and second UEs may span a larger bandwidth than a bandwidth taken up by the resources themselves. Sidelink communications (e.g., in an unlicensed spectrum) may be transmitted without power control, such that sidelink communications received at a greater distance may be associated with a lower received power than sidelink communications received at a closer distance (e.g., which may be referred to as a near-far effect).

A sidelink communication may be associated with in-band emissions that may cause power leakage into neighboring interlaced frequency resources, which may disrupt or mask communications in the neighboring frequency resources because of the near-far effect. For example, power leakage from an adjacent frequency resource used by the third UE may be greater than or equal to a received power in a frequency resource allocated to the sidelink communication between the first and second UEs (e.g., if a distance between the third and second UEs is less than a distance between the first and second UEs). Such power leakage may cause interference in receiving the sidelink communication, which may result in lower communication quality and reliability and may, in some cases, result in missing the sidelink communication.

The present disclosure provides techniques for reducing interference caused by power leakage by restricting frequency resources for the sidelink communication based on a distance between UEs reserving frequency resources in a same time window (e.g., a transmission time interval (TTI) or channel occupancy time (COT)). In some cases, a COT may additionally or alternatively be referred to as a channel occupancy. For example, the first UE may select resources or receive allocated resources (e.g., from a base station) for transmitting the sidelink communication to the second UE. When frequency resources are reserved for the sidelink communication (e.g., by the first UE or the base station) within a time window, the first UE or the base station may determine a distance parameter between the first UE and one or more other UEs (e.g., including the third UE) reserving frequency resources within the time window.

If the distance parameter is less than a threshold (e.g., the first and third UEs are in a similar location), the first UE or the base station may select frequency resources within the time window (e.g., because if the first and third UEs are in a similar location, the near-far effect may be reduced). If the distance parameter is greater than the threshold, the first UE or the base station may select frequency resources based on one or more restrictions. For example, the first UE or the base station may select frequency resources within a different time window or may select frequency resources at an offset from frequency resources reserved by the third UE. Doing so may, for example, reduce general power leakage interference because the first UE may transmit the sidelink communication within a time window or within frequency resources with reduced interference from power leakage.

The distance parameter may represent a physical distance between the first and third UEs, for example, based on broadcasted sidelink information that may include location information. Additionally or alternatively, the distance parameter may be represented by a reference signal received power (RSRP) of the third UE as measured by the first UE. In some examples, the base station or another UE may configure the distance parameter and the distance parameter threshold, for example, via configuration signaling or sidelink signaling.

If the base station selects the resources based on the distance parameter, the base station may allocate the resources to the first UE via a control message. The first UE may use the selected resources (e.g., selected by the first UE or the base station) to transmit the sidelink communication to the second UE. As described herein, using sidelink resources selected based on a distance parameter may decrease interference and increase communication quality and reliability.

Aspects of the disclosure are initially described in the context of wireless communications systems. Aspects of the disclosure are further illustrated by and described with reference to resource selection schemes, a process flow, apparatus diagrams, system diagrams, and flowcharts that relate to frequency multiplexing for sidelink transmissions.

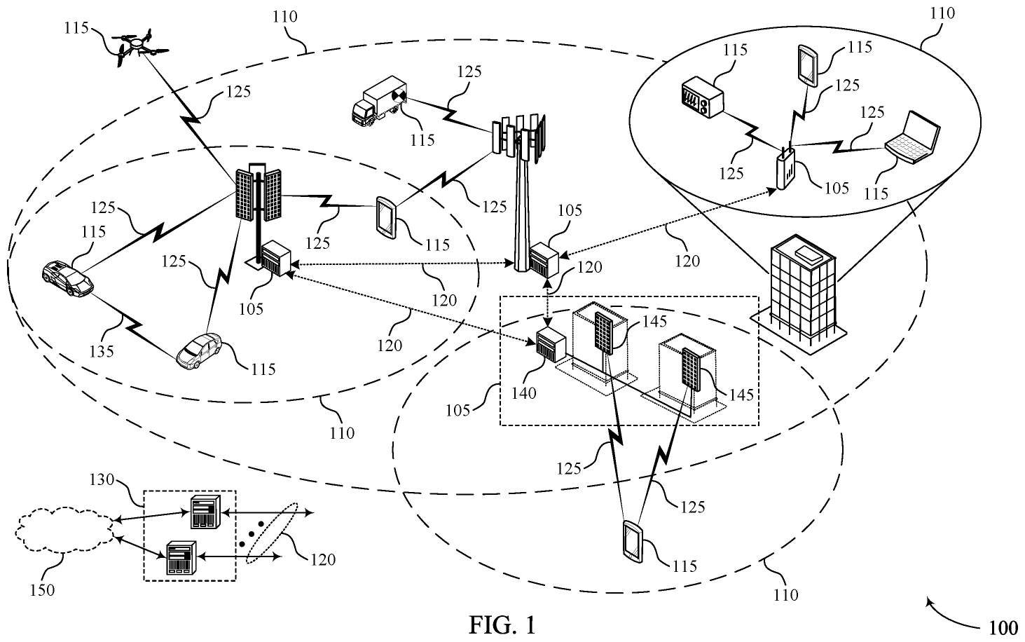

FIG. 1 illustrates an example of a wireless communications system 100 that supports frequency multiplexing for sidelink transmissions in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies. A base station 105 may represent or be referred to as a roadside unit (RSU), for example, that forms a part of a sidelink network.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to the network operators IP services 150. The operators IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A first UE 115 or a base station 105 may select communication resources for a sidelink communication based on a distance between UEs 115 reserving frequency resources in a same time window (e.g., TTI, channel occupancy, or COT). For example, the first UE 115 may select resources or receive allocated resources (e.g., from the base station 105) for transmitting the sidelink communication to a second UE 115. When frequency resources are reserved for the sidelink communication (e.g., by the first UE 115 or the base station 105), the first UE 115 or the base station 105 may determine a distance parameter between the first UE 115 and one or more other UEs 115 (e.g., including a third UE 115) reserving frequency resources within the time window. The distance parameter may represent a physical distance between the first and third UE 115, for example, based on broadcasted sidelink information that may include location information. Additionally or alternatively, the distance parameter may be represented by an RSRP of the third UE 115 as measured by the first UE 115.

If the distance parameter is less than a threshold (e.g., the first and third UE 115 are in a similar location), the first UE 115 or the base station 105 may select frequency resources within the time window. If the distance parameter is greater than the threshold, the first UE 115 or the base station 105 may select frequency resources based on one or more restrictions. For example, the first UE 115 or the base station 105 may select frequency resources within a different time window or may select frequency resources at an offset from frequency resources reserved by the third UE 115. Doing so may, for example, reduce general power leakage interference because the first UE 115 may transmit the sidelink communication within a time window or within frequency resources with reduced interference from power leakage. If the base station 105 selects the resources based on the distance parameter, the base station 105 may allocate the resources to the first UE 115 via a control message. The first UE 115 may use the selected resources (e.g., selected by the first UE 115 or the base station 105) to transmit the sidelink communication to the second UE 115.

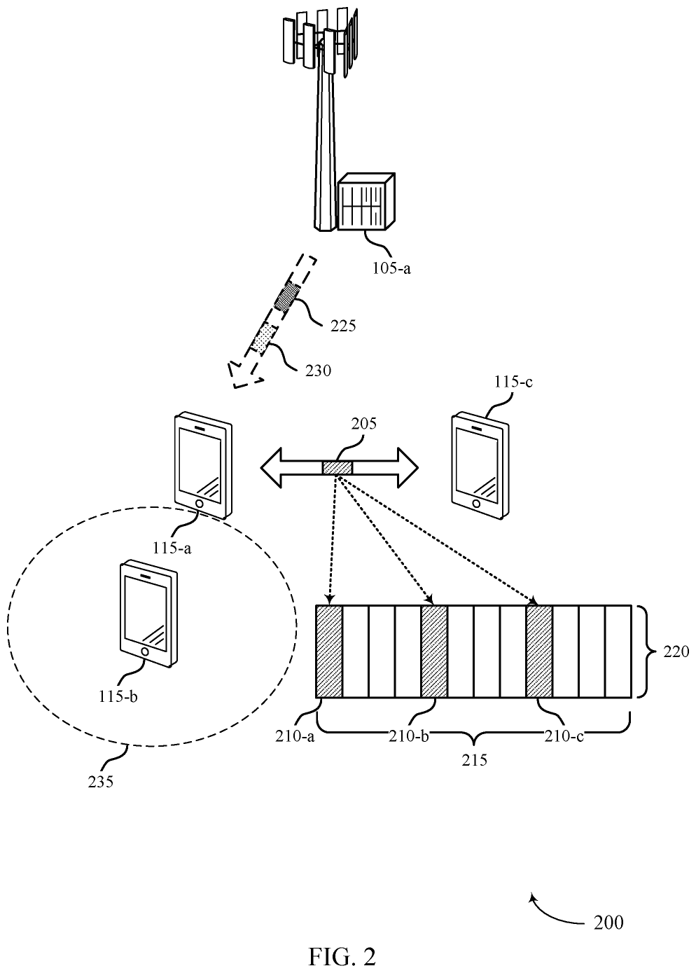

FIG. 2 illustrates an example of a wireless communications system 200 that supports frequency multiplexing for sidelink transmissions in accordance with aspects of the present disclosure. In some examples, wireless communications system 200 may implement aspects of wireless communications system 100. For example, wireless communications system 200 may include a base station 105-a and UEs 115-a, 115-b, and 115-c, which may be examples of a base station 105 and UEs 115 described with reference to FIG. 1. UEs 115-a, 115-b, and 115-c may represent examples of UEs 115 that may communicate using sidelink communications. For example, UEs 115-a and 115-c may communicate using sidelink communications, and UE 115-b may communicate with one or more UEs 115 using sidelink communications (e.g., may communicate with UE 115-a, UE 115-c, one or more other UEs 115, or any combination thereof).

Some sidelink communications (e.g., V2X sidelink communications) may communicate using a licensed frequency spectrum, for example, using a shared spectrum in a licensed cellular frequency band, or using a dedicated spectrum for intelligent transportation systems (ITS). In some cases, V2X or other sidelink communications may also communicate using unlicensed spectrum, for example, if licensed or ITS spectrum are unavailable in a geographic region. Unlicensed spectrum may be shared by other wireless communication technologies (e.g., Wi-Fi), and may also be associated with one or more conditions for spectrum usage. For example, a portion of a channel bandwidth may be configured to be occupied by communications associated with a UE 115, which may be referred to as an occupied channel bandwidth (OCB). For example, a transmission power from a device or UE 115 may be distributed over a first portion of the channel bandwidth (e.g., most of the channel bandwidth), although the device or UE 115 may be assigned frequency resources for transmission over a second portion of the channel bandwidth smaller than the first portion. In one example, at least 99 percent of transmission power of a UE 115 may be distributed to at least 80 percent of a channel bandwidth.

In order to cover the OCB, resources (e.g., one or more resource block (RBs) included in a sub-channel) allocated to the UE 115 may be interlaced with resources (e.g., one or more other RBs or sub-channels) allocated to other UEs 115, such that frequency distribution of the resources allocated to the UE 115 meets the OCB. Resources allocated to the UE 115 in this manner may be evenly spaced within the channel bandwidth, such that the OCB is covered. For example, frequency resources 210 for a sidelink communication 205 between UE 115-a and UE 115-c may be distributed to frequency resources 210-a, 210-b, and 210-c within a channel bandwidth 215. As such, each frequency resource 210 allocated for the sidelink communication 205 may be interlaced with one or more other frequency resources 210 allocated to one or more other UEs 115 (e.g., allocated to UE 115-b). The frequency resources 210 allocated to different sidelink communications 205 may be multiplexed in frequency in a same TTI 220, for example, using FDM techniques. A TTI 220 as described herein may represent a channel occupancy, a COT, a slot, or any other time window.

Sidelink communications 205 (e.g., in an unlicensed spectrum) may be transmitted without power control, for example, because each UE 115 may be configured to transmit a sidelink communication 205 by broadcasting the sidelink communication 205 with a highest transmit power (e.g., a same or similar power for each UE 115). Some sidelink communications 205 received from a greater distance may be associated with a lower received power than sidelink communications received from a closer distance (e.g., which may be referred to as a near-far effect). Accordingly, different frequency resources 210 within a same TTI 220 may be associated with different received powers at a UE 115, such as UE 115-c. For example, UE 115-c may receive sidelink communications 205 having a higher power from UEs 115 closer to UE 115-c, and may receive sidelink communications 205 having a lower power from UEs 115 farther from UE 115-c.

A received power may be associated with in-band emissions that may cause power leakage (e.g., a smaller power leakage than the received power) into neighboring interlaced frequency resources 210 (e.g., interlaced RBs). For example, in-band emissions may represent a ratio of received power in a non-allocated frequency resource 210 to received power in an allocated frequency resource 210. In-band emissions may include general power leakage to adjacent, non-allocated frequency resources 210, power leakage to a center of a frequency carrier, and power leakage to a frequency resource 210 on an opposite or mirror location within a carrier.

In some cases, the power leakage (e.g., general power leakage to adjacent frequency resources 210) may disrupt or mask communications in the neighboring frequency resources 210 because of the near-far effect. For example, general power leakage from an adjacent frequency resource 210 allocated to UE 115-b may be greater than or equal to a received power in a frequency resource 210 allocated to the sidelink communication 205 if a distance between UEs 115-b and 115-c is less than a distance between UEs 115-a and 115-c. Such power leakage may cause interference in receiving the sidelink communication 205, which may result in lower communication quality and reliability and may result in missing the sidelink communication 205.

The present disclosure provides techniques for reducing interference caused by power leakage by restricting frequency resources 210 for the sidelink communication 205 based on a distance to another UE 115 (e.g., UE 115-b) reserving frequency resources 210 in a same TTI 220. For example, UE 115-a may select resources or receive allocated resources (e.g., from base station 105-a, such as via a control message 225) for transmitting the sidelink communication 205 to UE 115-c. When frequency resources 210 are reserved for the sidelink communication 205 (e.g., by UE 115-a or base station 105-a) within a TTI 220, UE 115-a or base station 105-a may determine a distance parameter between UE 115-a and one or more other UEs 115 (e.g., including UE 115-b) reserving frequency resources 210 within the TTI 220.

If the distance parameter is less than a threshold (e.g., the two UEs 115 are in a similar location), UE 115-a or base station 105-a may select frequency resources 210 within the TTI 220. Doing so may, for example, reduce general power leakage interference because UEs 115-a and 115-b may be located at a similar distance from UE 115-c, which may reduce the near-far effect. If the distance parameter is greater than the threshold, UE 115-a or base station 105-a may select frequency resources 210 based on one or more restrictions. For example, UE 115-a or base station 105-a may exclude a frequency resource 210 that is close to a frequency resource 210 (e.g., in adjacent RBs, in a same TTI 220, or in a same COT) that has been reserved by or allocated to a UE 115 that is farther than the distance threshold. In some cases, UE 115-a or base station 105-a may select frequency resources 210 within a different TTI 220 or may select frequency resources 210 at an offset from frequency resources 210 reserved by a UE 115 associated with a distance parameter greater than the threshold. Doing so may, for example, reduce general power leakage interference because UE 115-a may transmit the sidelink communication 205 within a TTI 220 or within frequency resources 210 with reduced interference from general power leakage.

The distance parameter may represent a physical distance between two UEs 115 (e.g., distance 235), for example, based on broadcasted sidelink information that may include location information. Additionally or alternatively, the distance parameter may be represented by an RSRP received from another UE 115. For example, UE 115-a may determine an RSRP for UE 115-b or other UEs 115 based on an RSRP measurement when performing sidelink decoding. UE 115-a may determine location information for itself and may also determine location information for UE 115-b or other UEs 115 based on sidelink decoding. In some examples, base station 105-a or another UE 115 may configure the distance parameter and the distance parameter threshold for UEs 115-a and 115-b, for example, via configuration signaling (e.g., radio resource control (RRC) signaling, such as a configuration message 230).

When selecting or reserving resources for the sidelink communication 205, UE 115-a or base station 105-a may indicate reserved resources in one or more future TTIs 220. The one or more future TTIs 220 may include a TTI 220 that is adjacent or contiguous to the TTI 220 for the sidelink communication 205 or may be non-contiguous to the TTI 220 for the sidelink communication 205. The reserved resources in the one or more future TTIs 220 may also be based on the distance parameter. For example, frequency resources 210 in the one or more future TTIs may be selected based on the distance parameter and any restrictions resulting therefrom, as described herein. In some cases, a measured RSRP for UE 115-b or other UEs 115 may be projected to the one or more future TTIs 220 (e.g., in order to perform resource selection based on the distance parameter). Other UEs 115 that decode the TTI 220 for the sidelink communication 205 may determine the resources reserved by UE 115-a or base station 105-a for the one or more future TTIs 220 (e.g., based on the indication of the reserved resources) and may avoid selecting the reserved resources.

Resource selection may be triggered at UE 115-a or base station 105-a based on an arrival of a sidelink packet for transmission (e.g., based on an indication of the sidelink packet transmitted by UE 115-a to base station 105-a). UE 115-a or base station 105-a may select resources identified as available within a resource selection window, for example, based on a time and/or frequency location of resources reserved for other UEs 115 (e.g., based on sidelink decoding). For example, UE 115-a or base station 105-a may exclude resources for selection that have been reserved for other UEs 115, and remaining resources in the resource selection window may be identified as available resources. In some cases, UE 115-a or base station 105-a may also exclude resources for selection that have not been reserved for other UEs 115, but are close (e.g., in adjacent RBs, in a same TTI, or in a same COT) to a resource that has been reserved by a UE 115 which is farther than the distance threshold. For example, resources in a slot that includes resources reserved by a UE 115 farther than the distance threshold may be identified as unavailable and excluded from resource selection. Alternatively, resources that are located in adjacent RBs to a resource that has been reserved by a UE 115 farther than the distance threshold may be excluded from resource selection.

If base station 105-a performs resource allocation based on the distance parameter, base station 105-a may allocate the resources to UE 115-a via a control message 225. UE 115-a may use the selected resources (e.g., selected by UE 115-a or allocated by base station 105-a) to transmit the sidelink communication 205 to UE 115-c. As described herein, using sidelink resources selected based on a distance parameter may decrease interference and increase communication quality and reliability.

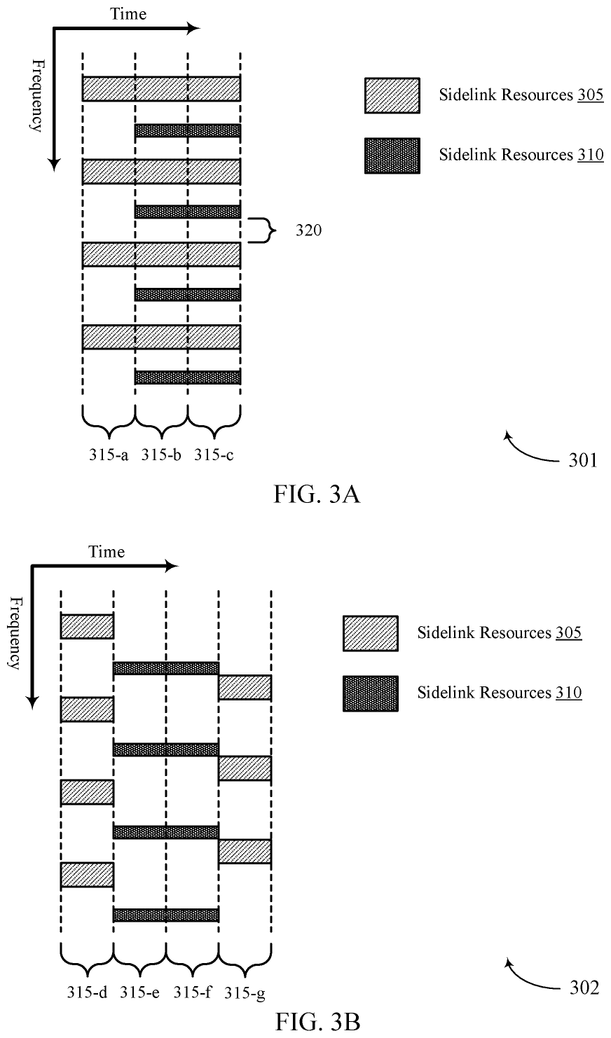

FIGS. 3A and 3B illustrate respective examples of resource selection schemes 301 and 302 that support frequency multiplexing for sidelink transmissions in accordance with aspects of the present disclosure. In some examples, resource selection schemes 301 and 302 may implement or be implemented by aspects of wireless communications system 100 or 200. For example, resource selection schemes 301 and 302 may be implemented by a first UE 115 or a base station 105, which may be examples of a UE 115 and a base station 105 described with reference to FIGS. 1 and 2. As described with reference to FIG. 2, the first UE 115 or the base station 105 may use resource selection scheme 301 or 302 to select resources for a sidelink communication based on a distance parameter.

In a first example, the first UE 115 or the base station 105 may determine the distance parameter based on an RSRP of a second UE 115, measured at the first UE 115. For example, the first UE 115 may measure the RSRP of the second UE 115 in TTI 315-a or TTI 315-d (e.g., based on a transmission from the second UE 115 using sidelink resources 305). The RSRP may be based on a reference signal transmitted by the second UE 115, such as a demodulation reference signal (DMRS) or a channel state information reference signal (CSI-RS), among other examples.

If the base station 105 is selecting the sidelink resources 310 for the sidelink communication, the first UE 115 may transmit an indication of the RSRP of the second UE 115 to the base station 105. In some cases, the base station 105 may configure the first UE 115 to report the RSRP, and in some cases, the first UE 115 may autonomously report the RSRP. In some cases, the first UE 115 may determine whether the RSRP meets a threshold and report the determination to the base station 105. A greater RSRP measured at the first UE 115 may indicate that the second UE 115 is closer to the first UE 115 (e.g., as opposed to a smaller RSRP, which may indicate the second UE 115 is farther away). As described with reference to FIG. 2, the first UE 115 or the base station 105 may select sidelink resources 310 for a sidelink communication for the first UE 115 based on the distance parameter and a threshold. If the distance parameter is based on or includes an RSRP, the threshold may also be based on or include an RSRP.

If the distance parameter is below or meets the threshold (e.g., indicates that the distance between the two UEs 115 is below a threshold), the first UE 115 or the base station 105 may select sidelink resources 310 in a TTI 315 that includes sidelink resources 305 reserved for the second UE 115. For example, if the RSRP of the second UE 115 is greater than an RSRP threshold, the first UE 115 or the base station 105 may identify and select unreserved or unallocated resources (e.g., available resources) in a TTI 315 that includes sidelink resources 305 reserved for the second UE 115, such as in TTIs 315-b or 315-c, as illustrated in FIG. 3A.

If the distance parameter is greater than or does not meet the threshold (e.g., indicates that the distance between the two UEs 115 is above a threshold), the first UE 115 or the base station 105 may perform selection of the sidelink resources 310 based on one or more restrictions. For example, if the RSRP of the second UE 115 is less than an RSRP threshold, the first UE 115 or the base station 105 may exclude resources from any TTIs 315 that include sidelink resources 305 reserved for the second UE 115 from resource selection, such as in TTIs 315-d and 315-g, as illustrated in FIG. 3B. As such, the first UE 115 or the base station 105 may select sidelink resources 310 in another TTI 315 that does not include sidelink resources 305 reserved for the second UE 115 (e.g., TTIs 315-e and 315-f).

In some cases, if the RSRP of the second UE 115 is greater than an RSRP threshold, the first UE 115 or the base station 105 may identify resources as unavailable that are adjacent in frequency to the sidelink resources 305 reserved by the second UE 115 in a TTI 315, and may identify resources as available that are not adjacent in frequency to the sidelink resources 305 reserved by the second UE 115 in a TTI 315. For example, the first UE 115 or the base station 105 may select resources from a TTI 315 that includes sidelink resources 305 reserved for the second UE 115 but at a frequency offset 320 from the sidelink resources 305 (e.g., such that the sidelink resources 310 and 305 may not be adjacent in frequency), such as in TTIs 315-b and 315-c, as illustrated in FIG. 3A.

The threshold (e.g., RSRP threshold) may be configured, for example, via configuration signaling (e.g., RRC signaling) from the base station 105 or another UE 115 or may be pre-configured and stored at the base station 105 or the first UE 115. If the first UE 115 or the base station 105 determines that TTI 315-a or 315-d includes sidelink resources reserved for multiple UEs 115, the base station 105 or the UE 115 may determine the distance parameter based on one UE 115 (e.g., a reference UE 115, as represented by the second UE 115) of the multiple UEs 115. The reference UE 115 may represent a UE 115 that initiated a COT used by the first UE 115 or a UE 115 with a smallest RSRP as measured by the first UE 115 (e.g., a farthest UE 115).

In a second example, the first UE 115 or the base station 105 may determine the distance parameter based on a location of the first UE 115 and a location of a second UE 115. For example, the second UE 115 may signal its location (e.g., an absolute location or a zone location) when transmitting sidelink communications via sidelink resources 305, such as in TTI 315-a or 315-d. The first UE 115 may decode a sidelink communication from the second UE 115 and may determine a distance between the first UE 115 and the second UE 115 based on the received location of the second UE 115 and the location of the first UE 115.

If the base station 105 is selecting the sidelink resources 310 for the sidelink communication, the first UE 115 may transmit, to the base station 105, an indication of a distance from the first UE 115 to the second UE 115, the location of the first UE 115, the location of the second UE 115, or any combination thereof. In some cases, the base station 105 may configure the first UE 115 and/or the second UE 115 to report their respective locations and/or distance, and in some cases, the first UE 115 and/or the second UE 115 may autonomously report their respective locations and/or distance. In some cases, the first UE 115 may determine whether the distance meets a threshold and report the determination to the base station 105. A smaller distance may indicate that the second UE 115 is closer to the first UE 115. As described with reference to FIG. 2, the first UE 115 or the base station 105 may select sidelink resources 310 for a sidelink communication for the first UE 115 based on the distance parameter and a threshold. If the distance parameter is based on or includes a distance, the threshold may also be based on or include a distance.

If the distance parameter is below or meets the threshold (e.g., indicates that the distance between the two UEs 115 is below a threshold), the first UE 115 or the base station 105 may identify that unreserved resources in a TTI 315 that includes sidelink resources 305 reserved for the second UE 115 are available and may select an available resource in the TTI 315. For example, if the distance is less than a distance threshold, the first UE 115 or the base station 105 may select sidelink resources 310 in a TTI 315 that includes sidelink resources 305 reserved for the second UE 115, such as in TTIs 315-b or 315-c, as illustrated in FIG. 3A.

If the distance parameter is greater than or does not meet the threshold (e.g., indicates that the distance between the two UEs 115 is above a threshold), the first UE 115 or the base station 105 may perform selection of the sidelink resources 310 based on one or more restrictions. For example, if the distance is greater than a distance threshold, the first UE 115 or the base station 105 may exclude resources from any TTIs 315 that include sidelink resources 305 reserved for the second UE 115, such as in TTIs 315-d and 315-g, as illustrated in FIG. 3B. In some cases, if the distance is greater than a distance threshold, the first UE 115 or the base station 105 may identify resources as unavailable that are adjacent in frequency to the sidelink resources 305 reserved by the second UE 115 in a TTI 315, and may identify the resources as available that are not adjacent in frequency to the sidelink resources 305 reserved by the second UE 115 in a TTI 315. For example, the first UE 115 or the base station 105 may select resources from a TTI 315 that includes sidelink resources 305 reserved for the second UE 115 but at a frequency offset 320 from the sidelink resources 305, such as in TTIs 315-b and 315-c, as illustrated in FIG. 3A.

The threshold (e.g., distance threshold) may be configured, for example, via configuration signaling (e.g., RRC signaling) from the base station 105 or another UE 115 or may be pre-configured. If the first UE 115 or the base station 105 determines that TTI 315-a or 315-d includes sidelink resources reserved for multiple UEs 115, the base station 105 or the UE 115 may determine the distance parameter based on one UE 115 (e.g., a reference UE 115, as represented by the second UE 115) of the multiple UEs 115. The reference UE 115 may represent a UE 115 that initiated a COT used by the first UE 115 or a UE 115 with a largest distance from the first UE 115 (e.g., a farthest UE 115).

In a third example, the first UE 115 or the base station 105 may determine the distance parameter based on a location of the first UE 115 and a location of a COT used for selecting sidelink resources 310 for the first UE 115. A COT may span a number of TTIs 315 and an indicated frequency range, and may, for example, be associated with one or more other UEs 115 (e.g., including a second UE 115). When a COT is initiated by a UE 115 (e.g., the second UE 115), the COT may be associated with location information. The location of the COT may be represented by a location of the UE 115 (e.g., or an RSU) initiating the COT, an absolute geographical location, or a zone location (e.g., as represented by a zone identifier (ID)). The location of the COT may be transmitted as part of the COT information, for example, within one or more sidelink control information (SCI) messages transmitted by the one or more UEs 115 sharing the COT. The base station 105 or the first UE 115 may determine the distance parameter based on a distance between the location of the COT and the location of the first UE 115.

If the distance parameter is below or meets a threshold (e.g., indicates that the distance between the first UE 115 and the location of the COT is below a threshold), the first UE 115 or the base station 105 may select sidelink resources 310 in a TTI 315 that is included in the COT (e.g., including sidelink resources 305 reserved for the second UE 115). In one example, if the distance is less than a distance threshold, the first UE 115 or the base station 105 may select sidelink resources 310 in a TTI 315 included in the COT, such as in TTIs 315-b or 315-c that include sidelink resources 305, as illustrated in FIG. 3A. In another example, if the zone ID for the first UE is the same as the zone ID of the location of the COT, the first UE 115 or the base station 105 may select sidelink resources 310 in a TTI 315 included in the COT, such as in TTIs 315-b or 315-c that include sidelink resources 305, as illustrated in FIG. 3A.

If the distance parameter is greater than or does not meet the threshold (e.g., indicates that the distance between the first UE 115 and the location of the COT is above a threshold), the first UE 115 or the base station 105 may perform selection of the sidelink resources 310 based on one or more restrictions. For example, if the distance is greater than a distance threshold, the first UE 115 or the base station 105 may refrain from transmitting in the COT, for example, the first UE 115 or the base station 105 may exclude resources included the COT from resource selection or resource allocation, such as in TTIs 315-d and 315-g, as illustrated in FIG. 3B.

The threshold (e.g., distance threshold) distance from the COT location may be configured, for example, as part of the COT sharing information or may be configured via configuration signaling (e.g., RRC signaling) from the base station 105 or another UE 115, or may be pre-configured.

If the base station 105 selects the sidelink resources 310, the base station 105 may allocate the resources to the first UE 115. The first UE 115 may use the selected resources (e.g., selected by the first UE 115 or the base station 105) to transmit a sidelink communication to a third UE 115. As described herein, using sidelink resources 310 selected based on a distance parameter may decrease interference and increase communication quality and reliability.

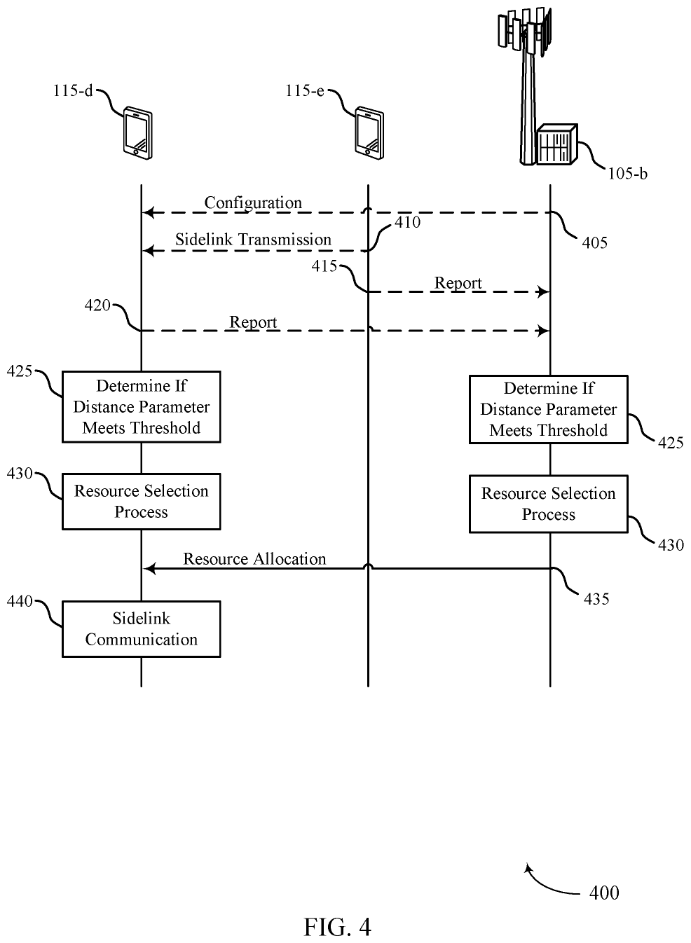

FIG. 4 illustrates an example of a process flow 400 that supports frequency multiplexing for sidelink transmissions in accordance with aspects of the present disclosure.

In some examples, process flow 400 may implement or be implemented by aspects of wireless communications system 100 or 200. For example, process flow 400 may be implemented by a base station 105-b and UEs 115-d and 115-e, which may be examples of a base station 105 and UEs 115 described herein with reference to FIGS. 1-3. As described with reference to FIGS. 2 and 3, UE 115-d or base station 105-b may use aspects of process flow 400 to select resources for a sidelink communication, based on a distance parameter.

In the following description of process flow 400, the operations between base station 105-b and UEs 115-d and 115-e may be transmitted in a different order than the order shown, or the operations performed by base station 105-b and UEs 115-d and 115-e may be performed in different orders or at different times. For example, specific operations may also be left out of process flow 400, or other operations may be added to process flow 400. Although base station 105-b and UEs 115-d and 115-e are shown performing the operations of process flow 400, some aspects of some operations may also be performed by one or more other wireless devices.

At 405, in some cases, base station 105-b may transmit an indication of a configuration to UE 115-d , UE 115-e, or both. The configuration may indicate, for example, for UEs 115-d and 115-e to report information used to determine a distance parameter or may indicate for UE 115-d (e.g., or UE 115-e) to report whether a distance parameter meets a threshold. The information used to determine a distance parameter may include an RSRP of UE 115-e as measured by UE 115-d, a location of one or both of UEs 115-d and 115-e, a distance between UEs 115-d and 115-e, or any combination thereof. In some cases, the configuration may indicate a distance parameter to use for selecting resources (e.g., an RSRP, a distance, or a COT location) and/or may indicate a threshold for the distance parameter for selecting resources (e.g., an RSRP threshold, a distance threshold, or a COT location threshold). In some cases, the configuration may indicate whether UE 115-d or whether base station 105-b is to select resources for UE 115-d. In some cases, UE 115-d, UE 115-e, or both may be pre-configured with some or all of the information included in the configuration. In some cases, another UE 115 may transmit the indication of the configuration to UE 115-d, UE 115-e, or both.

At 410, in some cases, UE 115-e may broadcast a sidelink transmission that may be received by UE 115-d. UE 115-d may use the sidelink transmission to determine or measure an RSRP of UE 115-e, or may use the sidelink transmission to identify a location of UE 115-e (e.g., using location information associated with the sidelink transmission).

At 415 and 420, UE 115-e and UE 115-d may, respectively, report to base station 105-b the information used to determine the distance parameter. For example, UE 115-e or UE 115-d, or both, may report an RSRP of UE 115-e as measured by UE 115-d, a location of one or both of UEs 115-d and 115-e, a distance between UEs 115-d and 115-e, or any combination thereof. Additionally or alternatively, UE 115-d may report whether the distance parameter meets (e.g., is less than or greater than) the threshold.

At 425, UE 115-d or base station 105-b may determine whether the distance parameter meets the threshold (e.g., is greater than or less than the threshold). In some examples described herein, UE 115-d or base station 105-b may determine whether the RSRP of UE 115-e is greater than an RSRP threshold. In some examples described herein, UE 115-d or base station 105-b may determine whether a distance between UE 115-e and UE 115-d is less than a threshold or if a distance between UE 115-d and a COT location is less than a threshold.

At 430, UE 115-d or base station 105-b may perform a selection process or allocation process for a frequency resource for a frequency multiplexed sidelink communication at UE 115-d. UE 115-d or base station 105-b may perform the selection process or allocation process within a time window (e.g., TTI or COT) that includes a communication resource allocated to UE 115-e or another UE 115. UE 115-d or base station 105-b may perform the selection process based on determining whether the distance parameter meets the threshold. For example, if the distance parameter meets the threshold, UE 115-d or base station 105-b may identify available frequency communication resources and select a frequency communication resource within the time window. If the distance parameter fails to meet the threshold (e.g., is greater than or less than the threshold), UE 115-d or base station 105-b may identify that frequency communication resources adjacent in frequency to the communication resource allocated to UE 115-e or within the time window are unavailable for allocation. UE 115-d or base station 105-b may identify available resources within the time window or a different time window and may select a frequency communication resource from the available resources (e.g., based on one or more restrictions, such as using a different time window or using a frequency offset between the frequency communication resource and the communication resource allocated to UE 115-e).

At 435, if base station 105-b allocates the frequency communication resource, base station 105-b may allocate resources to the UE 115-d for the frequency multiplexed sidelink communication based on the selection or allocation process (e.g., allocating the selected frequency communication resource). For example, base station 105-b may transmit an indication (e.g., via a control message) of the selected frequency communication resource to UE 115-d.

At 440, UE 115-d may transmit the frequency multiplexed sidelink communication based on the selection process (e.g., using the selected or allocated frequency communication resource). For example, UE 115-d may transmit the frequency multiplexed sidelink communication to another UE 115 using the frequency communication resource selected by UE 115-d or allocated by base station 105-b.

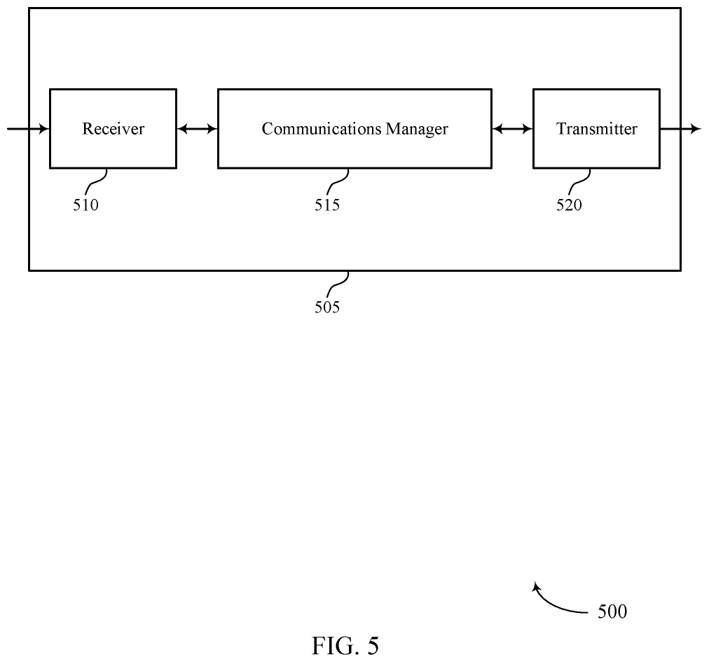

FIG. 5 shows a block diagram 500 of a device 505 that supports frequency multiplexing for sidelink transmissions in accordance with aspects of the present disclosure. The device 505 may be an example of aspects of a UE 115 as described herein. The device 505 may include a receiver 510, a communications manager 515, and a transmitter 520. The device 505 may also include a processor. Each of these components may be in communication with one another (e.g., via one or more buses).

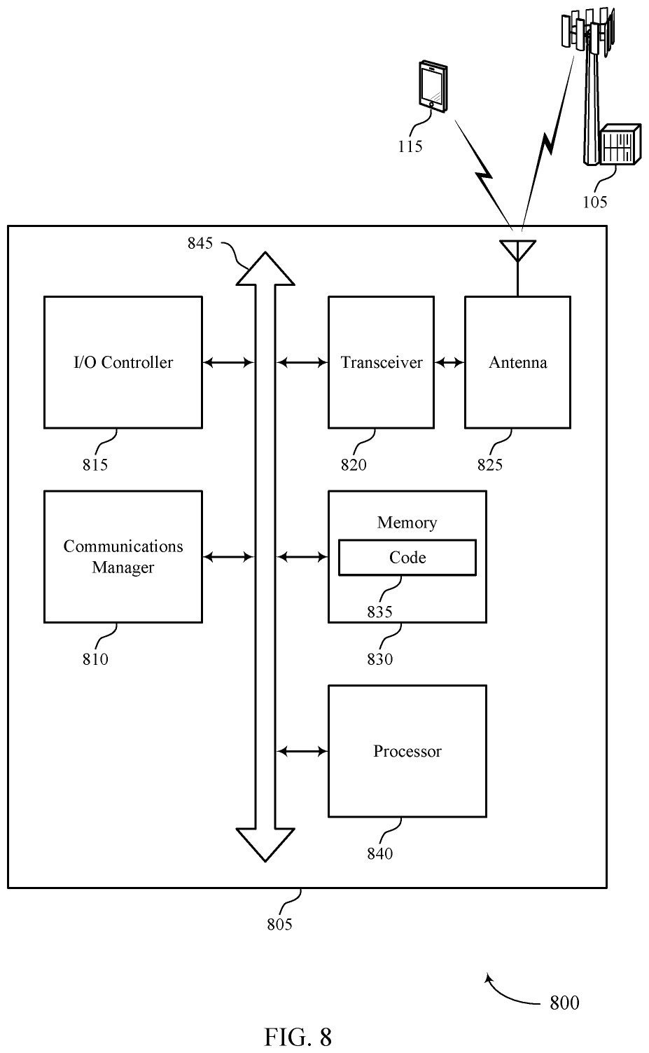

The receiver 510 may receive information such as packets, user data, or control information associated with various information channels (e.g., control channels, data channels, and information related to frequency multiplexing for sidelink transmissions, etc.). Information may be passed on to other components of the device 505. The receiver 510 may be an example of aspects of the transceiver 820 described with reference to FIG. 8. The receiver 510 may utilize a single antenna or a set of antennas.

The communications manager 515 may identify a distance parameter associated with a first UE and a second UE, determine whether the distance parameter is less than a threshold, perform, within a time window that includes a communication resource allocated to the second UE and based on determining whether the distance parameter is less than the threshold, a selection process for a frequency resource for a frequency multiplexed sidelink communication, and transmit the frequency multiplexed sidelink communication based on the selection process. The communications manager 515 may be an example of aspects of the communications manager 810 described herein.

The communications manager 515, or its sub-components, may be implemented in hardware, code (e.g., software or firmware) executed by a processor, or any combination thereof. If implemented in code executed by a processor, the functions of the communications manager 515, or its sub-components may be executed by a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described in the present disclosure.

The communications manager 515, or its sub-components, may be physically located at various positions, including being distributed such that portions of functions are implemented at different physical locations by one or more physical components. In some examples, the communications manager 515, or its sub-components, may be a separate and distinct component in accordance with various aspects of the present disclosure. In some examples, the communications manager 515, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 520 may transmit signals generated by other components of the device 505. In some examples, the transmitter 520 may be collocated with a receiver 510 in a transceiver module. For example, the transmitter 520 may be an example of aspects of the transceiver 820 described with reference to FIG. 8. The transmitter 520 may utilize a single antenna or a set of antennas.

The actions performed by the communications manager 515, among other examples herein, may be implemented to realize one or more potential advantages. For example, communications manager 515 may increase communication quality and reduce interference at a wireless device (e.g., a UE 115) by determining a frequency resource for a sidelink communication based on a distance between two UEs 115. The increase in communication quality may result in increased link performance and decreased overhead based on determining a frequency resource for a sidelink communication based on a distance between two UEs 115. Accordingly, communications manager 515 may save power and increase battery life at a wireless device (e.g., a UE 115) by strategically increasing a quality of communications at a wireless device (e.g., a UE 115).

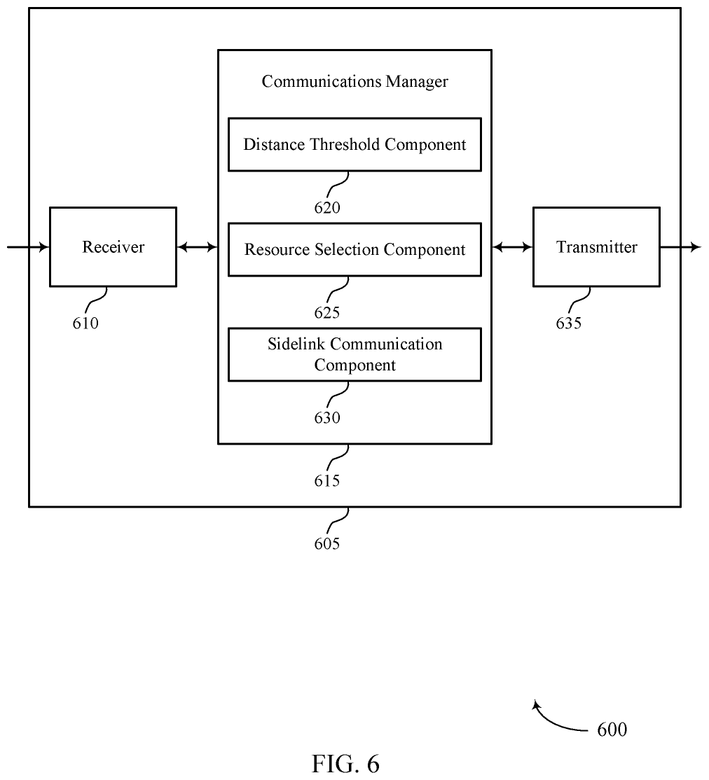

FIG. 6 shows a block diagram 600 of a device 605 that supports frequency multiplexing for sidelink transmissions in accordance with aspects of the present disclosure. The device 605 may be an example of aspects of a device 505, or a UE 115 as described herein. The device 605 may include a receiver 610, a communications manager 615, and a transmitter 635. The device 605 may also include a processor. Each of these components may be in communication with one another (e.g., via one or more buses).

The receiver 610 may receive information such as packets, user data, or control information associated with various information channels (e.g., control channels, data channels, and information related to frequency multiplexing for sidelink transmissions, etc.). Information may be passed on to other components of the device 605. The receiver 610 may be an example of aspects of the transceiver 820 described with reference to FIG. 8. The receiver 610 may utilize a single antenna or a set of antennas.

The communications manager 615 may be an example of aspects of the communications manager 515 as described herein. The communications manager 615 may include a distance threshold component 620, a resource selection component 625, and a sidelink communication component 630. The communications manager 615 may be an example of aspects of the communications manager 810 described herein.

The distance threshold component 620 may identify a distance parameter associated with a first UE and a second UE, and determine whether the distance parameter is less than a threshold.

The resource selection component 625 may perform, within a time window that includes a communication resource allocated to the second UE and based on determining whether the distance parameter is less than the threshold, a selection process for a frequency resource for a frequency multiplexed sidelink communication.

The sidelink communication component 630 may transmit the frequency multiplexed sidelink communication based on the selection process.

The transmitter 635 may transmit signals generated by other components of the device 605. In some examples, the transmitter 635 may be collocated with a receiver 610 in a transceiver module. For example, the transmitter 635 may be an example of aspects of the transceiver 820 described with reference to FIG. 8. The transmitter 635 may utilize a single antenna or a set of antennas.

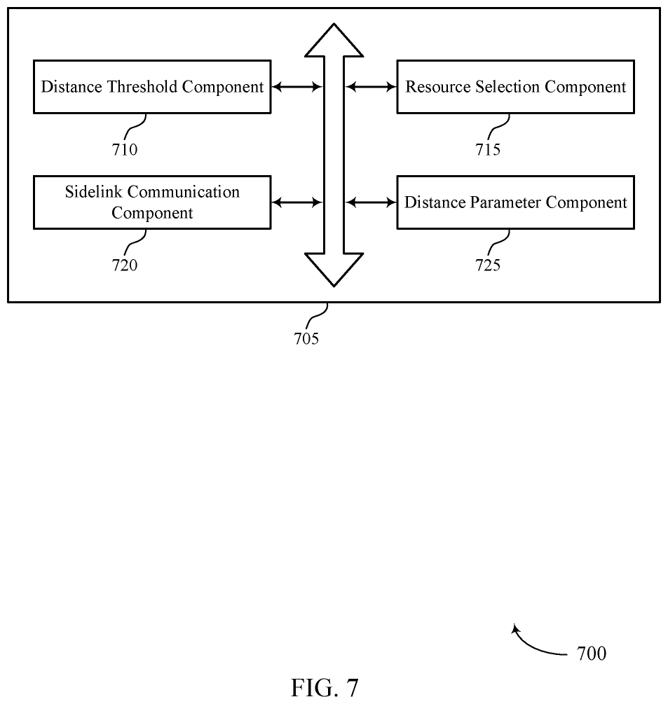

A processor of a wireless device (e.g., controlling the receiver 610, the transmitter 635, or the transceiver 820 as described with reference to FIG. 8) may increase communication reliability and quality. The increased communication quality may reduce power consumption (e.g., via implementation of system components described with reference to FIG. 7) compared to other systems and techniques, for example, that do not support determining a frequency resource for a sidelink communication based on a distance between two UEs 115, which may decrease communication quality and increase power consumption. Further, the processor of the UE 115 may identify one or more aspects of a distance parameter or a distance parameter threshold. The processor of the wireless device may use the distance parameter or distance parameter threshold to perform one or more actions that may result in increased communication quality and power consumption, as well as save power and increase battery life at the wireless device (e.g., by strategically supporting selective resource allocation, which may increase communication quality), among other benefits.

FIG. 7 shows a block diagram 700 of a communications manager 705 that supports frequency multiplexing for sidelink transmissions in accordance with aspects of the present disclosure. The communications manager 705 may be an example of aspects of a communications manager 515, a communications manager 615, or a communications manager 810 described herein. The communications manager 705 may include a distance threshold component 710, a resource selection component 715, a sidelink communication component 720, and a distance parameter component 725. Each of these modules may communicate, directly or indirectly, with one another (e.g., via one or more buses).

The distance threshold component 710 may identify a distance parameter associated with a first UE and a second UE, and determine whether the distance parameter is less than a threshold. In some examples, the distance threshold component 710 may determine that the distance parameter is less than the threshold. In some examples, the distance threshold component 710 may determine that the distance parameter is greater than the threshold. In some examples, the distance threshold component 710 may determine that the distance parameter is less than the threshold based on a zone ID associated with the first UE being a same zone ID associated with the channel occupancy time. In some examples, the distance threshold component 710 may receive configuration signaling indicating the threshold.

The resource selection component 715 may perform, within a time window that includes a communication resource allocated to the second UE and based on determining whether the distance parameter is less than the threshold, a selection process for a frequency resource for a frequency multiplexed sidelink communication. In some cases, a set of UEs including the second UE are allocated respective communication resources within the time window.

In some examples, the resource selection component 715 may select the frequency resource for the frequency multiplexed sidelink communication within the time window based on the distance parameter being less than the threshold. In some examples, the resource selection component 715 may identify a restriction for the frequency resource for the frequency multiplexed sidelink communication based on the distance parameter being greater than the threshold. In some examples, the resource selection component 715 may select the frequency resource for the frequency multiplexed sidelink communication based on the restriction.

In some examples, the resource selection component 715 may exclude, based on the restriction, frequency resources within the time window from candidate resources for selecting the frequency resource. In some examples, the resource selection component 715 may select, based on the restriction, the frequency resource for the frequency multiplexed sidelink communication within the time window and offset in frequency from the communication resource allocated to the second UE. In some examples, the resource selection component 715 may receive configuration signaling indicating the offset in frequency.

The sidelink communication component 720 may transmit the frequency multiplexed sidelink communication based on the selection process.

The distance parameter component 725 may determine the distance parameter based on measuring an RSRP from the second UE, where the distance parameter and the threshold include respective RSRPs. In some examples, the distance parameter component 725 may determine the distance parameter based on a location of the first UE and an indication of a location of the second UE, where the distance parameter and the threshold include respective distances. In some examples, the distance parameter component 725 may determine the distance parameter based on a location of the first UE and a location of a COT used by the second UE, where the distance parameter and the threshold include respective distances. In some cases, the location of the COT includes a location of a wireless device that initiates the COT. In some cases, the location of the COT includes a geographic location or geographic zone associated with the COT. In some cases, the location of the COT is received via COT sharing information or is configured for the COT.

In some cases, a set of UEs including the second UE are allocated respective communication resources within the time window. In some cases, the second UE has a smallest RSRP relative to the first UE out of the set of UEs. In some cases, the second UE has a largest distance from the first UE out of the set of UEs. In some cases, the second UE initiates a COT used by the first UE and the second UE.

FIG. 8 shows a diagram of a system 800 including a device 805 that supports frequency multiplexing for sidelink transmissions in accordance with aspects of the present disclosure. The device 805 may be an example of or include the components of device 505, device 605, or a UE 115 as described herein. The device 805 may include components for bi-directional voice and data communications including components for transmitting and receiving communications, including a communications manager 810, an I/O controller 815, a transceiver 820, an antenna 825, memory 830, and a processor 840. These components may be in electronic communication via one or more buses (e.g., bus 845).

The communications manager 810 may identify a distance parameter associated with a first UE and a second UE, determine whether the distance parameter is less than a threshold, perform, within a time window that includes a communication resource allocated to the second UE and based on determining whether the distance parameter is less than the threshold, a selection process for a frequency resource for a frequency multiplexed sidelink communication, and transmit the frequency multiplexed sidelink communication based on the selection process.

The I/O controller 815 may manage input and output signals for the device 805. The I/O controller 815 may also manage peripherals not integrated into the device 805. In some cases, the I/O controller 815 may represent a physical connection or port to an external peripheral. In some cases, the I/O controller 815 may utilize an operating system such as iOS®, ANDROID®, MS-DOS®, MS-WINDOWS®, OS/2®, UNIX®, LINUX®, or another known operating system. In other cases, the I/O controller 815 may represent or interact with a modem, a keyboard, a mouse, a touchscreen, or a similar device. In some cases, the I/O controller 815 may be implemented as part of a processor. In some cases, a user may interact with the device 805 via the I/O controller 815 or via hardware components controlled by the I/O controller 815.

The transceiver 820 may communicate bi-directionally, via one or more antennas, wired, or wireless links as described above. For example, the transceiver 820 may represent a wireless transceiver and may communicate bi-directionally with another wireless transceiver. The transceiver 820 may also include a modem to modulate the packets and provide the modulated packets to the antennas for transmission, and to demodulate packets received from the antennas.

In some cases, the wireless device may include a single antenna 825. However, in some cases the device may have more than one antenna 825, which may be capable of concurrently transmitting or receiving multiple wireless transmissions.

The memory 830 may include random access memory (RAM) and read only memory (ROM). The memory 830 may store computer-readable, computer-executable code 835 including instructions that, when executed, cause the processor to perform various functions described herein. In some cases, the memory 830 may contain, among other things, a basic I/O system (BIOS) which may control basic hardware or software operation such as the interaction with peripheral components or devices.

The processor 840 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In other cases, a memory controller may be integrated into the processor 840. The processor 840 may be configured to execute computer-readable instructions stored in a memory (e.g., the memory 830) to cause the device 805 to perform various functions (e.g., functions or tasks supporting frequency multiplexing for sidelink transmissions).

The code 835 may include instructions to implement aspects of the present disclosure, including instructions to support wireless communications. The code 835 may be stored in a non-transitory computer-readable medium such as system memory or other type of memory. In some cases, the code 835 may not be directly executable by the processor 840 but may cause a computer (e.g., when compiled and executed) to perform functions described herein.

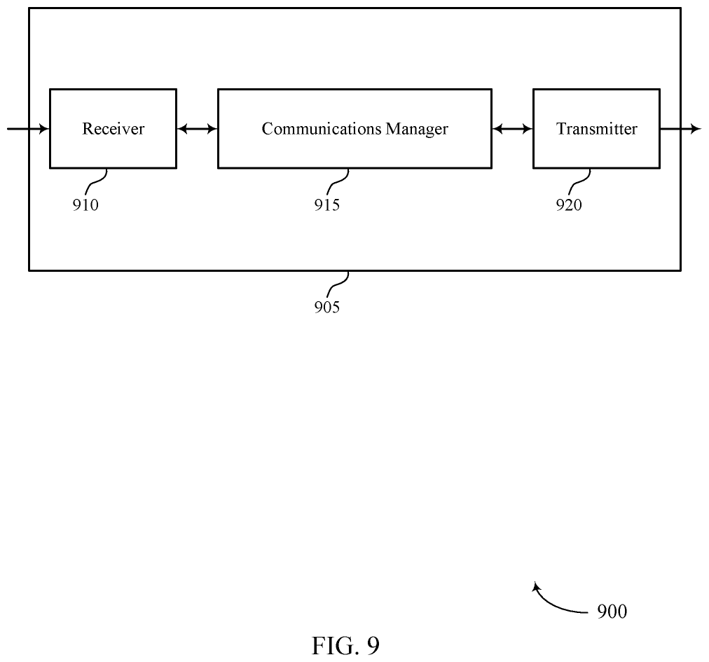

FIG. 9 shows a block diagram 900 of a device 905 that supports frequency multiplexing for sidelink transmissions in accordance with aspects of the present disclosure. The device 905 may be an example of aspects of a base station 105 as described herein. The device 905 may include a receiver 910, a communications manager 915, and a transmitter 920. The device 905 may also include a processor. Each of these components may be in communication with one another (e.g., via one or more buses).

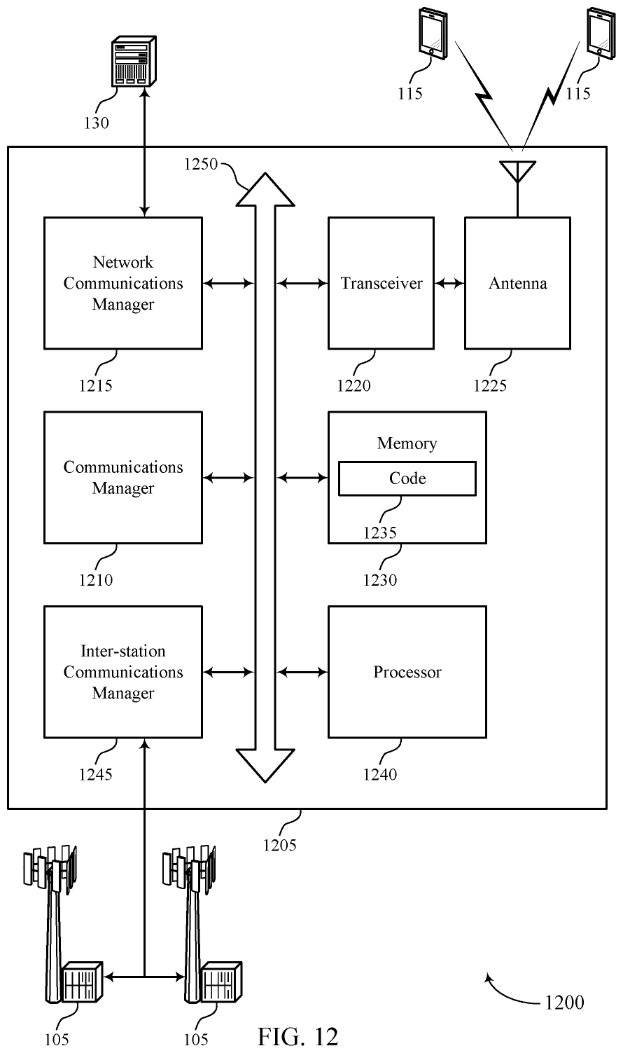

The receiver 910 may receive information such as packets, user data, or control information associated with various information channels (e.g., control channels, data channels, and information related to frequency multiplexing for sidelink transmissions, etc.). Information may be passed on to other components of the device 905. The receiver 910 may be an example of aspects of the transceiver 1220 described with reference to FIG. 12. The receiver 910 may utilize a single antenna or a set of antennas.

The communications manager 915 may identify a distance parameter associated with a first UE and a second UE, determine whether the distance parameter is less than a threshold, perform, within a time window that includes a communication associated with the second UE and based on determining whether the distance parameter is less than the threshold, a selection process for a frequency resource for a frequency multiplexed sidelink communication for the first UE, and allocate resources to the first UE for the frequency multiplexed sidelink communication based on the selection process. The communications manager 915 may be an example of aspects of the communications manager 1210 described herein.

The communications manager 915, or its sub-components, may be implemented in hardware, code (e.g., software or firmware) executed by a processor, or any combination thereof. If implemented in code executed by a processor, the functions of the communications manager 915, or its sub-components may be executed by a general-purpose processor, a DSP, an ASIC, a FPGA or other programmable logic device, discrete gate or transistor logic, discrete hardware components, or any combination thereof designed to perform the functions described in the present disclosure.

The communications manager 915, or its sub-components, may be physically located at various positions, including being distributed such that portions of functions are implemented at different physical locations by one or more physical components. In some examples, the communications manager 915, or its sub-components, may be a separate and distinct component in accordance with various aspects of the present disclosure. In some examples, the communications manager 915, or its sub-components, may be combined with one or more other hardware components, including but not limited to an I/O component, a transceiver, a network server, another computing device, one or more other components described in the present disclosure, or a combination thereof in accordance with various aspects of the present disclosure.

The transmitter 920 may transmit signals generated by other components of the device 905. In some examples, the transmitter 920 may be collocated with a receiver 910 in a transceiver module. For example, the transmitter 920 may be an example of aspects of the transceiver 1220 described with reference to FIG. 12. The transmitter 920 may utilize a single antenna or a set of antennas.

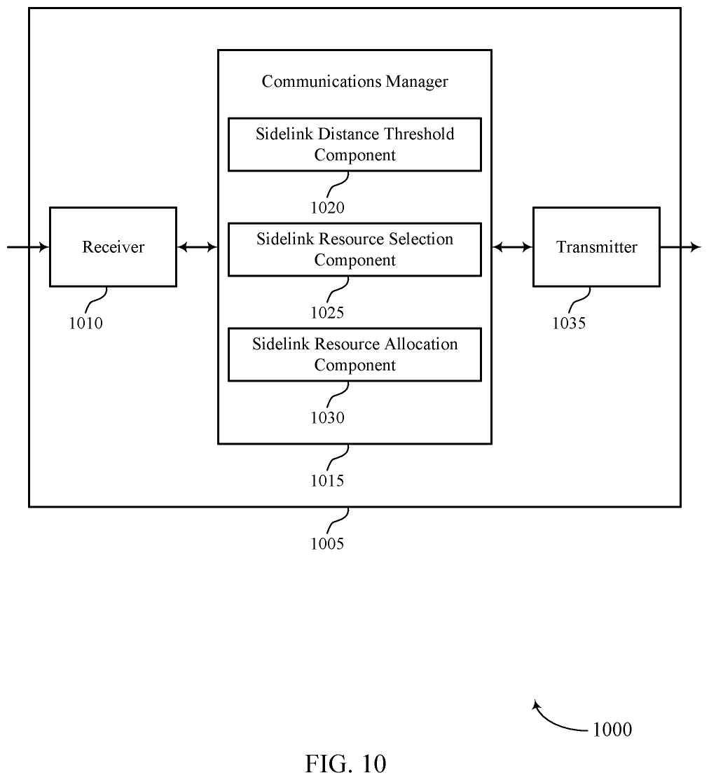

FIG. 10 shows a block diagram 1000 of a device 1005 that supports frequency multiplexing for sidelink transmissions in accordance with aspects of the present disclosure. The device 1005 may be an example of aspects of a device 905, or a base station 105 as described herein. The device 1005 may include a receiver 1010, a communications manager 1015, and a transmitter 1035. The device 1005 may also include a processor. Each of these components may be in communication with one another (e.g., via one or more buses).

The receiver 1010 may receive information such as packets, user data, or control information associated with various information channels (e.g., control channels, data channels, and information related to frequency multiplexing for sidelink transmissions, etc.). Information may be passed on to other components of the device 1005. The receiver 1010 may be an example of aspects of the transceiver 1220 described with reference to FIG. 12. The receiver 1010 may utilize a single antenna or a set of antennas.

The communications manager 1015 may be an example of aspects of the communications manager 915 as described herein. The communications manager 1015 may include a sidelink distance threshold component 1020, a sidelink resource selection component 1025, and a sidelink resource allocation component 1030. The communications manager 1015 may be an example of aspects of the communications manager 1210 described herein.

The sidelink distance threshold component 1020 may identify a distance parameter associated with a first UE and a second UE, and determine whether the distance parameter is less than a threshold.

The sidelink resource selection component 1025 may perform, within a time window that includes a communication associated with the second UE and based on determining whether the distance parameter is less than the threshold, a selection process for a frequency resource for a frequency multiplexed sidelink communication for the first UE.

The sidelink resource allocation component 1030 may allocate resources to the first UE for the frequency multiplexed sidelink communication based on the selection process.

The transmitter 1035 may transmit signals generated by other components of the device 1005. In some examples, the transmitter 1035 may be collocated with a receiver 1010 in a transceiver module. For example, the transmitter 1035 may be an example of aspects of the transceiver 1220 described with reference to FIG. 12. The transmitter 1035 may utilize a single antenna or a set of antennas.

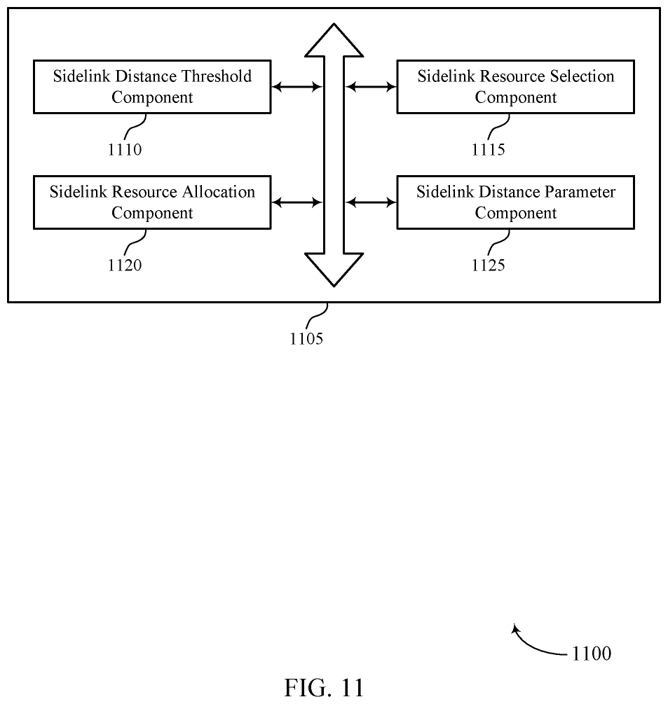

FIG. 11 shows a block diagram 1100 of a communications manager 1105 that supports frequency multiplexing for sidelink transmissions in accordance with aspects of the present disclosure. The communications manager 1105 may be an example of aspects of a communications manager 915, a communications manager 1015, or a communications manager 1210 described herein. The communications manager 1105 may include a sidelink distance threshold component 1110, a sidelink resource selection component 1115, a sidelink resource allocation component 1120, and a sidelink distance parameter component 1125. Each of these modules may communicate, directly or indirectly, with one another (e.g., via one or more buses).

The sidelink distance threshold component 1110 may identify a distance parameter associated with a first UE and a second UE, and determine whether the distance parameter is less than a threshold. In some examples, the sidelink distance threshold component 1110 may determine that the distance parameter is less than the threshold. In some examples, the sidelink distance threshold component 1110 may determine that the distance parameter is greater than the threshold.

The sidelink resource selection component 1115 may perform, within a time window that includes a communication associated with the second UE and based on determining whether the distance parameter is less than the threshold, a selection process for a frequency resource for a frequency multiplexed sidelink communication for the first UE.

The sidelink resource allocation component 1120 may allocate resources to the first UE for the frequency multiplexed sidelink communication based on the selection process. In some examples, the sidelink resource allocation component 1120 may allocate the frequency resource for the frequency multiplexed sidelink communication within the time window based on the distance parameter being less than the threshold. In some examples, the sidelink resource allocation component 1120 may identify a restriction for the frequency resource for the frequency multiplexed sidelink communication based on the distance parameter being greater than the threshold. In some examples, the sidelink resource allocation component 1120 may allocate the frequency resource for the frequency multiplexed sidelink communication based on the restriction.

In some examples, the sidelink resource allocation component 1120 may allocate, based on the restriction, the frequency resource for the frequency multiplexed sidelink communication within a second time window different than the time window. In some examples, the sidelink resource allocation component 1120 may allocate, based on the restriction, the frequency resource for the frequency multiplexed sidelink communication within the time window and offset in frequency from the communication resource allocated to the second UE. In some examples, the sidelink resource allocation component 1120 may communicate configuration signaling indicating the offset in frequency.

The sidelink distance parameter component 1125 may determine the distance parameter based on receiving an indication, from the first UE, of an RSRP of the second UE, where the distance parameter and the threshold include respective RSRPs. In some examples, the sidelink distance parameter component 1125 may transmit, to the first UE and the second UE, an indication to report a measurement of an RSRP for determining the distance parameter. In some cases, a set of UEs including the second UE are allocated respective communication resources within the time window and the second UE has a smallest RSRP relative to the first UE out of the set of UEs.

In some examples, the sidelink distance parameter component 1125 may determine the distance parameter based on receiving an indication of a location of the first UE and an indication of a location of the second UE, where the distance parameter and the threshold include respective distances. In some examples, the sidelink distance parameter component 1125 may transmit, to the first UE and the second UE, an indication to report a measurement of a location for determining the distance parameter. In some cases, a set of UEs including the second UE are allocated respective communication resources within the time window and the second UE has a largest distance from the first UE out of the set of UEs. In some cases, the second UE initiates a COT used by the first UE and the second UE.

In some examples, the sidelink distance parameter component 1125 may receive the distance parameter from the first UE based on a location or an RSRP of the second UE determined by the first UE.

FIG. 12 shows a diagram of a system 1200 including a device 1205 that supports frequency multiplexing for sidelink transmissions in accordance with aspects of the present disclosure. The device 1205 may be an example of or include the components of device 905, device 1005, or a base station 105 as described herein. The device 1205 may include components for bi-directional voice and data communications including components for transmitting and receiving communications, including a communications manager 1210, a network communications manager 1215, a transceiver 1220, an antenna 1225, memory 1230, a processor 1240, and an inter-station communications manager 1245. These components may be in electronic communication via one or more buses (e.g., bus 1250).

The communications manager 1210 may identify a distance parameter associated with a first UE and a second UE, determine whether the distance parameter is less than a threshold, perform, within a time window that includes a communication associated with the second UE and based on determining whether the distance parameter is less than the threshold, a selection process for a frequency resource for a frequency multiplexed sidelink communication for the first UE, and allocate resources to the first UE for the frequency multiplexed sidelink communication based on the selection process.

The network communications manager 1215 may manage communications with the core network (e.g., via one or more wired backhaul links). For example, the network communications manager 1215 may manage the transfer of data communications for client devices, such as one or more UEs 115.

The transceiver 1220 may communicate bi-directionally, via one or more antennas, wired, or wireless links as described above. For example, the transceiver 1220 may represent a wireless transceiver and may communicate bi-directionally with another wireless transceiver. The transceiver 1220 may also include a modem to modulate the packets and provide the modulated packets to the antennas for transmission, and to demodulate packets received from the antennas.

In some cases, the wireless device may include a single antenna 1225. However, in some cases the device may have more than one antenna 1225, which may be capable of concurrently transmitting or receiving multiple wireless transmissions.

The memory 1230 may include RAM, ROM, or a combination thereof. The memory 1230 may store computer-readable code 1235 including instructions that, when executed by a processor (e.g., the processor 1240) cause the device to perform various functions described herein. In some cases, the memory 1230 may contain, among other things, a BIOS which may control basic hardware or software operation such as the interaction with peripheral components or devices.

The processor 1240 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some cases, a memory controller may be integrated into processor 1240. The processor 1240 may be configured to execute computer-readable instructions stored in a memory (e.g., the memory 1230) to cause the device 1205 to perform various functions (e.g., functions or tasks supporting frequency multiplexing for sidelink transmissions).

The inter-station communications manager 1245 may manage communications with other base station 105, and may include a controller or scheduler for controlling communications with UEs 115 in cooperation with other base stations 105. For example, the inter-station communications manager 1245 may coordinate scheduling for transmissions to UEs 115 for various interference mitigation techniques such as beamforming or joint transmission. In some examples, the inter-station communications manager 1245 may provide an X2 interface within an LTE/LTE-A wireless communication network technology to provide communication between base stations 105.

The code 1235 may include instructions to implement aspects of the present disclosure, including instructions to support wireless communications. The code 1235 may be stored in a non-transitory computer-readable medium such as system memory or other type of memory. In some cases, the code 1235 may not be directly executable by the processor 1240 but may cause a computer (e.g., when compiled and executed) to perform functions described herein.

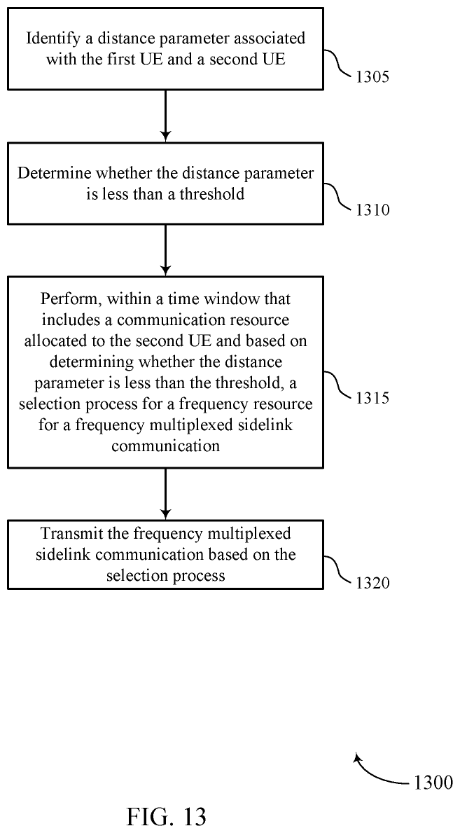

FIG. 13 shows a flowchart illustrating a method 1300 that supports frequency multiplexing for sidelink transmissions in accordance with aspects of the present disclosure. The operations of method 1300 may be implemented by a UE 115 or its components as described herein. For example, the operations of method 1300 may be performed by a communications manager as described with reference to FIGS. 5 through 8. In some examples, a first UE may execute a set of instructions to control the functional elements of the first UE to perform the functions described below. Additionally or alternatively, a UE may perform aspects of the functions described below using special-purpose hardware.

At 1305, the first UE may identify a distance parameter associated with the first UE and a second UE. The operations of 1305 may be performed according to the methods described herein. In some examples, aspects of the operations of 1305 may be performed by a distance threshold component as described with reference to FIGS. 5 through 8.

At 1310, the first UE may determine whether the distance parameter is less than a threshold. The operations of 1310 may be performed according to the methods described herein. In some examples, aspects of the operations of 1310 may be performed by a distance threshold component as described with reference to FIGS. 5 through 8.

At 1315, the first UE may perform, within a time window that includes a communication resource allocated to the second UE and based on determining whether the distance parameter is less than the threshold, a selection process for a frequency resource for a frequency multiplexed sidelink communication. The operations of 1315 may be performed according to the methods described herein. In some examples, aspects of the operations of 1315 may be performed by a resource selection component as described with reference to FIGS. 5 through 8.

At 1320, the first UE may transmit the frequency multiplexed sidelink communication based on the selection process. The operations of 1320 may be performed according to the methods described herein. In some examples, aspects of the operations of 1320 may be performed by a sidelink communication component as described with reference to FIGS. 5 through 8.

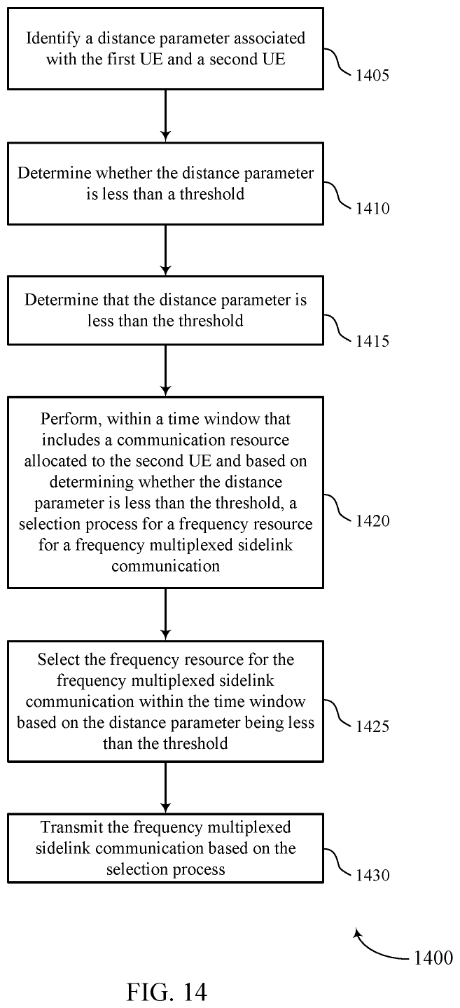

FIG. 14 shows a flowchart illustrating a method 1400 that supports frequency multiplexing for sidelink transmissions in accordance with aspects of the present disclosure. The operations of method 1400 may be implemented by a UE 115 or its components as described herein. For example, the operations of method 1400 may be performed by a communications manager as described with reference to FIGS. 5 through 8. In some examples, a first UE may execute a set of instructions to control the functional elements of the first UE to perform the functions described below. Additionally or alternatively, a UE may perform aspects of the functions described below using special-purpose hardware.

At 1405, the first UE may identify a distance parameter associated with the first UE and a second UE. The operations of 1405 may be performed according to the methods described herein. In some examples, aspects of the operations of 1405 may be performed by a distance threshold component as described with reference to FIGS. 5 through 8.

At 1410, the first UE may determine whether the distance parameter is less than a threshold. The operations of 1410 may be performed according to the methods described herein. In some examples, aspects of the operations of 1410 may be performed by a distance threshold component as described with reference to FIGS. 5 through 8.

At 1415, the first UE may determine that the distance parameter is less than the threshold. The operations of 1415 may be performed according to the methods described herein. In some examples, aspects of the operations of 1415 may be performed by a distance threshold component as described with reference to FIGS. 5 through 8.

At 1420, the first UE may perform, within a time window that includes a communication resource allocated to the second UE and based on determining whether the distance parameter is less than the threshold, a selection process for a frequency resource for a frequency multiplexed sidelink communication. The operations of 1420 may be performed according to the methods described herein. In some examples, aspects of the operations of 1420 may be performed by a resource selection component as described with reference to FIGS. 5 through 8.

At 1425, the first UE may select the frequency resource for the frequency multiplexed sidelink communication within the time window based on the distance parameter being less than the threshold. The operations of 1425 may be performed according to the methods described herein. In some examples, aspects of the operations of 1425 may be performed by a resource selection component as described with reference to FIGS. 5 through 8.

At 1430, the first UE may transmit the frequency multiplexed sidelink communication based on the selection process. The operations of 1430 may be performed according to the methods described herein. In some examples, aspects of the operations of 1430 may be performed by a sidelink communication component as described with reference to FIGS. 5 through 8.

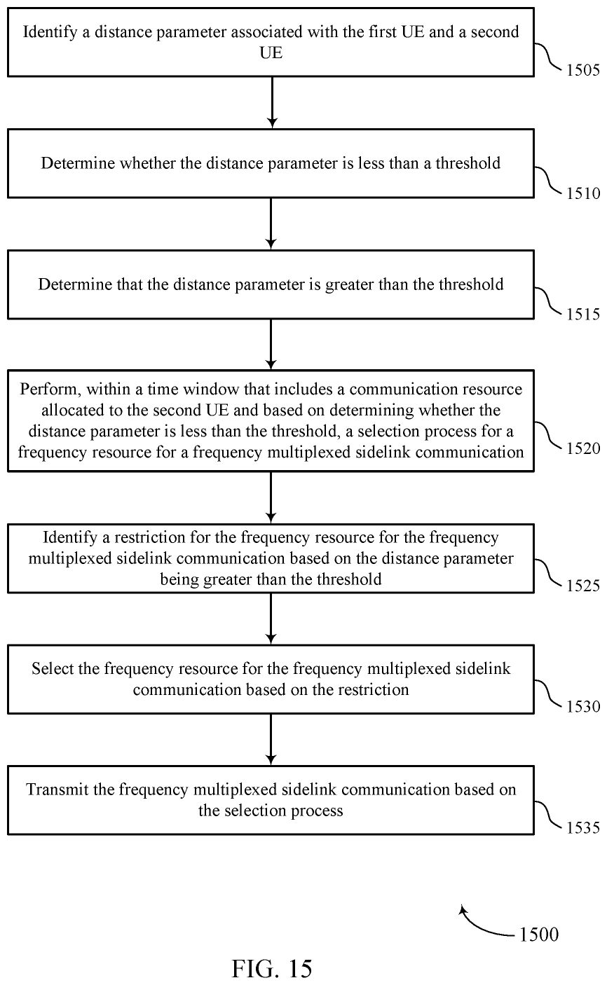

FIG. 15 shows a flowchart illustrating a method 1500 that supports frequency multiplexing for sidelink transmissions in accordance with aspects of the present disclosure. The operations of method 1500 may be implemented by a UE 115 or its components as described herein. For example, the operations of method 1500 may be performed by a communications manager as described with reference to FIGS. 5 through 8. In some examples, a first UE may execute a set of instructions to control the functional elements of the first UE to perform the functions described below. Additionally or alternatively, a UE may perform aspects of the functions described below using special-purpose hardware.

At 1505, the first UE may identify a distance parameter associated with the first UE and a second UE. The operations of 1505 may be performed according to the methods described herein. In some examples, aspects of the operations of 1505 may be performed by a distance threshold component as described with reference to FIGS. 5 through 8.

At 1510, the first UE may determine whether the distance parameter is less than a threshold. The operations of 1510 may be performed according to the methods described herein. In some examples, aspects of the operations of 1510 may be performed by a distance threshold component as described with reference to FIGS. 5 through 8.

At 1515, the first UE may determine that the distance parameter is greater than the threshold. The operations of 1515 may be performed according to the methods described herein. In some examples, aspects of the operations of 1515 may be performed by a distance threshold component as described with reference to FIGS. 5 through 8.

At 1520, the first UE may perform, within a time window that includes a communication resource allocated to the second UE and based on determining whether the distance parameter is less than the threshold, a selection process for a frequency resource for a frequency multiplexed sidelink communication. The operations of 1520 may be performed according to the methods described herein. In some examples, aspects of the operations of 1520 may be performed by a resource selection component as described with reference to FIGS. 5 through 8.

At 1525, the first UE may identify a restriction for the frequency resource for the frequency multiplexed sidelink communication based on the distance parameter being greater than the threshold. The operations of 1525 may be performed according to the methods described herein. In some examples, aspects of the operations of 1525 may be performed by a resource selection component as described with reference to FIGS. 5 through 8.

At 1530, the first UE may select the frequency resource for the frequency multiplexed sidelink communication based on the restriction. The operations of 1530 may be performed according to the methods described herein. In some examples, aspects of the operations of 1530 may be performed by a resource selection component as described with reference to FIGS. 5 through 8.

At 1535, the first UE may transmit the frequency multiplexed sidelink communication based on the selection process. The operations of 1535 may be performed according to the methods described herein. In some examples, aspects of the operations of 1535 may be performed by a sidelink communication component as described with reference to FIGS. 5 through 8.

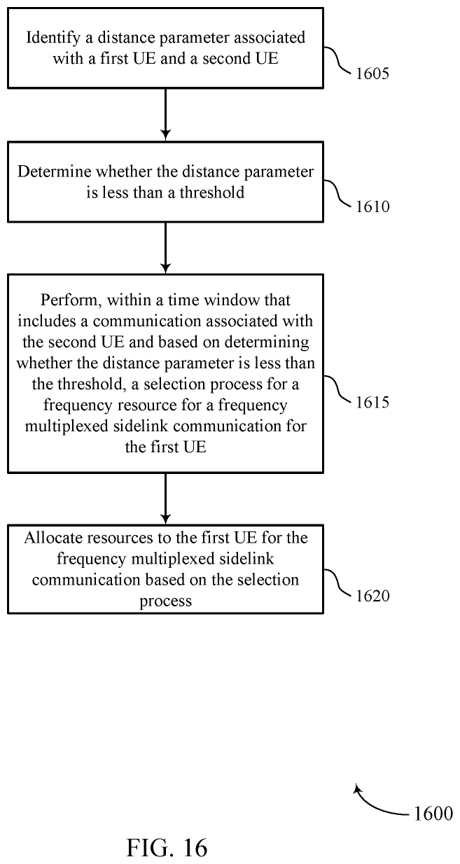

FIG. 16 shows a flowchart illustrating a method 1600 that supports frequency multiplexing for sidelink transmissions in accordance with aspects of the present disclosure. The operations of method 1600 may be implemented by a base station 105 or its components as described herein. For example, the operations of method 1600 may be performed by a communications manager as described with reference to FIGS. 9 through 12. In some examples, a base station may execute a set of instructions to control the functional elements of the base station to perform the functions described below. Additionally or alternatively, a base station may perform aspects of the functions described below using special-purpose hardware.

At 1605, the base station may identify a distance parameter associated with a first UE and a second UE. The operations of 1605 may be performed according to the methods described herein. In some examples, aspects of the operations of 1605 may be performed by a sidelink distance threshold component as described with reference to FIGS. 9 through 12.

At 1610, the base station may determine whether the distance parameter is less than a threshold. The operations of 1610 may be performed according to the methods described herein. In some examples, aspects of the operations of 1610 may be performed by a sidelink distance threshold component as described with reference to FIGS. 9 through 12.

At 1615, the base station may perform, within a time window that includes a communication associated with the second UE and based on determining whether the distance parameter is less than the threshold, a selection process for a frequency resource for a frequency multiplexed sidelink communication for the first UE. The operations of 1615 may be performed according to the methods described herein. In some examples, aspects of the operations of 1615 may be performed by a sidelink resource selection component as described with reference to FIGS. 9 through 12.

At 1620, the base station may allocate resources to the first UE for the frequency multiplexed sidelink communication based on the selection process. The operations of 1620 may be performed according to the methods described herein. In some examples, aspects of the operations of 1620 may be performed by a sidelink resource allocation component as described with reference to FIGS. 9 through 12.

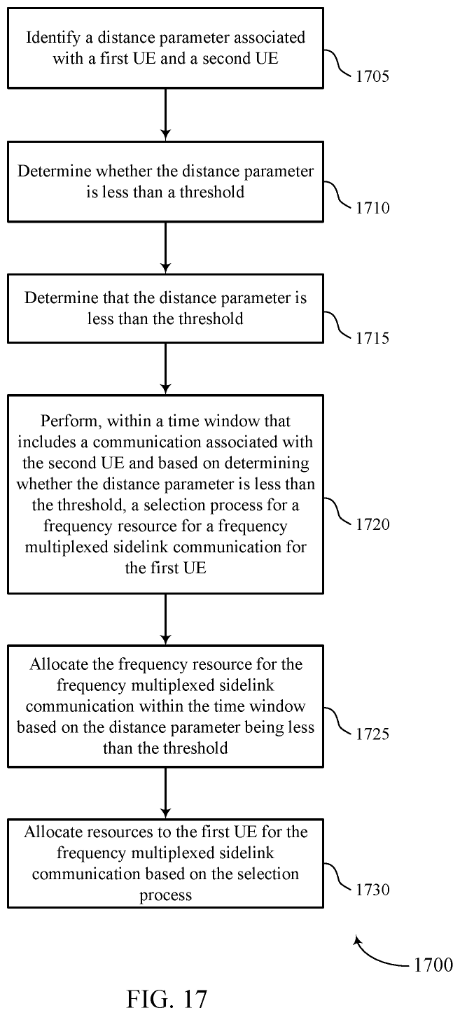

FIG. 17 shows a flowchart illustrating a method 1700 that supports frequency multiplexing for sidelink transmissions in accordance with aspects of the present disclosure. The operations of method 1700 may be implemented by a base station 105 or its components as described herein. For example, the operations of method 1700 may be performed by a communications manager as described with reference to FIGS. 9 through 12. In some examples, a base station may execute a set of instructions to control the functional elements of the base station to perform the functions described below. Additionally or alternatively, a base station may perform aspects of the functions described below using special-purpose hardware.

At 1705, the base station may identify a distance parameter associated with a first UE and a second UE. The operations of 1705 may be performed according to the methods described herein. In some examples, aspects of the operations of 1705 may be performed by a sidelink distance threshold component as described with reference to FIGS. 9 through 12.

At 1710, the base station may determine whether the distance parameter is less than a threshold. The operations of 1710 may be performed according to the methods described herein. In some examples, aspects of the operations of 1710 may be performed by a sidelink distance threshold component as described with reference to FIGS. 9 through 12.

At 1715, the base station may determine that the distance parameter is less than the threshold. The operations of 1715 may be performed according to the methods described herein. In some examples, aspects of the operations of 1715 may be performed by a sidelink distance threshold component as described with reference to FIGS. 9 through 12.

At 1720, the base station may perform, within a time window that includes a communication associated with the second UE and based on determining whether the distance parameter is less than the threshold, a selection process for a frequency resource for a frequency multiplexed sidelink communication for the first UE. The operations of 1720 may be performed according to the methods described herein. In some examples, aspects of the operations of 1720 may be performed by a sidelink resource selection component as described with reference to FIGS. 9 through 12.

At 1725, the base station may allocate the frequency resource for the frequency multiplexed sidelink communication within the time window based on the distance parameter being less than the threshold. The operations of 1725 may be performed according to the methods described herein. In some examples, aspects of the operations of 1725 may be performed by a sidelink resource allocation component as described with reference to FIGS. 9 through 12.

At 1730, the base station may allocate resources to the first UE for the frequency multiplexed sidelink communication based on the selection process. The operations of 1730 may be performed according to the methods described herein. In some examples, aspects of the operations of 1730 may be performed by a sidelink resource allocation component as described with reference to FIGS. 9 through 12.

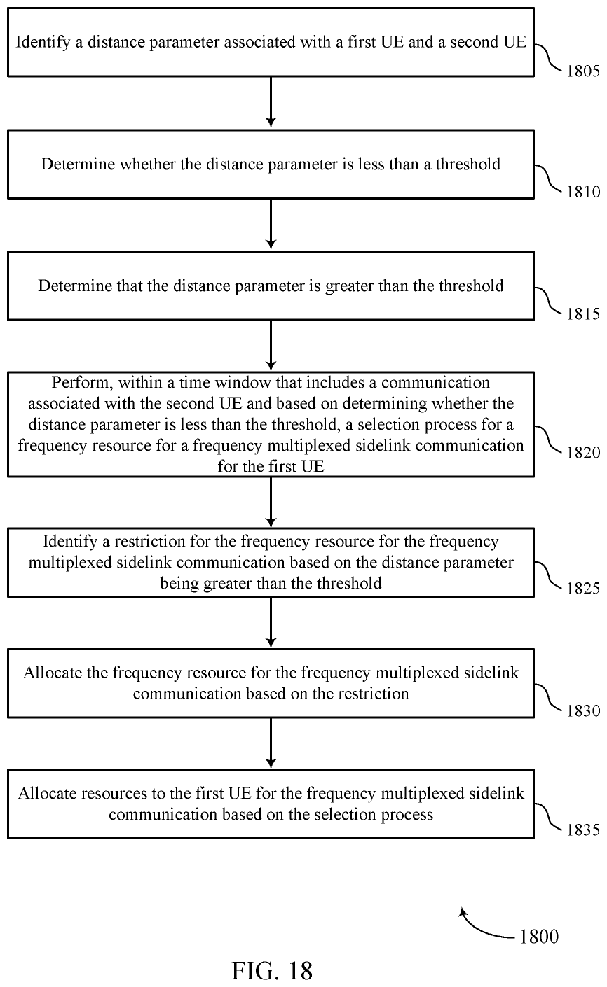

FIG. 18 shows a flowchart illustrating a method 1800 that supports frequency multiplexing for sidelink transmissions in accordance with aspects of the present disclosure. The operations of method 1800 may be implemented by a base station 105 or its components as described herein. For example, the operations of method 1800 may be performed by a communications manager as described with reference to FIGS. 9 through 12. In some examples, a base station may execute a set of instructions to control the functional elements of the base station to perform the functions described below. Additionally or alternatively, a base station may perform aspects of the functions described below using special-purpose hardware.

At 1805, the base station may identify a distance parameter associated with a first UE and a second UE. The operations of 1805 may be performed according to the methods described herein. In some examples, aspects of the operations of 1805 may be performed by a sidelink distance threshold component as described with reference to FIGS. 9 through 12.

At 1810, the base station may determine whether the distance parameter is less than a threshold. The operations of 1810 may be performed according to the methods described herein. In some examples, aspects of the operations of 1810 may be performed by a sidelink distance threshold component as described with reference to FIGS. 9 through 12.

At 1815, the base station may determine that the distance parameter is greater than the threshold. The operations of 1815 may be performed according to the methods described herein. In some examples, aspects of the operations of 1815 may be performed by a sidelink distance threshold component as described with reference to FIGS. 9 through 12.

At 1820, the base station may perform, within a time window that includes a communication associated with the second UE and based on determining whether the distance parameter is less than the threshold, a selection process for a frequency resource for a frequency multiplexed sidelink communication for the first UE. The operations of 1820 may be performed according to the methods described herein. In some examples, aspects of the operations of 1820 may be performed by a sidelink resource selection component as described with reference to FIGS. 9 through 12.

At 1825, the base station may identify a restriction for the frequency resource for the frequency multiplexed sidelink communication based on the distance parameter being greater than the threshold. The operations of 1825 may be performed according to the methods described herein. In some examples, aspects of the operations of 1825 may be performed by a sidelink resource allocation component as described with reference to FIGS. 9 through 12.

At 1830, the base station may allocate the frequency resource for the frequency multiplexed sidelink communication based on the restriction. The operations of 1830 may be performed according to the methods described herein. In some examples, aspects of the operations of 1830 may be performed by a sidelink resource allocation component as described with reference to FIGS. 9 through 12.

At 1835, the base station may allocate resources to the first UE for the frequency multiplexed sidelink communication based on the selection process. The operations of 1835 may be performed according to the methods described herein. In some examples, aspects of the operations of 1835 may be performed by a sidelink resource allocation component as described with reference to FIGS. 9 through 12.

It should be noted that the methods described herein describe possible implementations, and that the operations and the steps may be rearranged or otherwise modified and that other implementations are possible. Further, aspects from two or more of the methods may be combined.

The following provides an overview of aspects of the present disclosure:

Aspect 1: A method for wireless communications at a first UE, comprising: identifying a distance parameter associated with the first UE and a second UE; determining whether the distance parameter is less than a threshold; performing, within a time window that includes a communication resource allocated to the second UE and based at least in part on determining whether the distance parameter is less than the threshold, a selection process for a frequency resource for a frequency multiplexed sidelink communication; and transmitting the frequency multiplexed sidelink communication based at least in part on the selection process.

Aspect 2: The method of aspect 1, further comprising: determining that the distance parameter is less than the threshold; and selecting the frequency resource for the frequency multiplexed sidelink communication within the time window based at least in part on the distance parameter being less than the threshold.

Aspect 3: The method of aspect 1, further comprising: determining that the distance parameter is greater than the threshold; identifying a restriction for the frequency resource for the frequency multiplexed sidelink communication based at least in part on the distance parameter being greater than the threshold; and selecting the frequency resource for the frequency multiplexed sidelink communication based at least in part on the restriction.

Aspect 4: The method of aspect 3, wherein selecting the frequency resource comprises: excluding, based at least in part on the restriction, frequency resources within the time window from candidate resources for selecting the frequency resource.

Aspect 5: The method of aspect 3, wherein selecting the frequency resource comprises: selecting, based at least in part on the restriction, the frequency resource for the frequency multiplexed sidelink communication within the time window and offset in frequency from the communication resource allocated to the second UE.

Aspect 6: The method of aspect 5, further comprising: receiving configuration signaling indicating the offset in frequency.

Aspect 7: The method of any of aspects 1 through 6, wherein identifying the distance parameter comprises: determining the distance parameter based at least in part on measuring an RSRP from the second UE, wherein the distance parameter and the threshold comprise respective RSRPs.

Aspect 8: The method of aspect 7, wherein a plurality of UEs comprising the second UE are allocated respective communication resources within the time window and the second UE has a smallest RSRP relative to the first UE out of the plurality of UEs.

Aspect 9: The method of any of aspects 1 through 6, wherein identifying the distance parameter comprises: determining the distance parameter based at least in part on a location of the first UE and an indication of a location of the second UE, wherein the distance parameter and the threshold comprise respective distances.

Aspect 10: The method of aspect 9, wherein a plurality of UEs comprising the second UE are allocated respective communication resources within the time window; and the second UE has a largest distance from the first UE out of the plurality of UEs.

Aspect 11: The method of any of aspects 1 through 10, wherein a plurality of UEs comprising the second UE are allocated respective communication resources within the time window and the second UE initiates a COT used by the first UE and the second UE.

Aspect 12: The method of any of aspects 1 through 6 and 11, wherein identifying the distance parameter comprises: determining the distance parameter based at least in part on a location of the first UE and a location of a COT used by the second UE, wherein the distance parameter and the threshold comprise respective distances.

Aspect 13: The method of aspect 12, wherein the location of the COT comprises a location of a wireless device that initiates the COT.

Aspect 14: The method of any of aspects 12 through 13, wherein the location of the COT comprises a geographic location or geographic zone associated with the COT.

Aspect 15: The method of aspect 14, wherein determining whether the distance parameter is less than the threshold comprises: determining that the distance parameter is less than the threshold based at least in part on a zone ID associated with the first UE being a same zone ID associated with the COT.

Aspect 16: The method of any of aspects 12 through 15, wherein the location of the COT is received via COT sharing information or is configured for the COT.

Aspect 17: The method of any of aspects 1 through 16, further comprising: receiving configuration signaling indicating the threshold.

Aspect 18: A method for wireless communications at a base station, comprising: identifying a distance parameter associated with a first UE and a second UE; determining whether the distance parameter is less than a threshold; performing, within a time window that comprises a communication associated with the second UE and based at least in part on determining whether the distance parameter is less than the threshold, a selection process for a frequency resource for a frequency multiplexed sidelink communication for the first UE; and allocating resources to the first UE for the frequency multiplexed sidelink communication based at least in part on the selection process.

Aspect 19: The method of aspect 18, further comprising: determining that the distance parameter is less than the threshold; and allocating the frequency resource for the frequency multiplexed sidelink communication within the time window based at least in part on the distance parameter being less than the threshold.

Aspect 20: The method of aspect 18, further comprising: determining that the distance parameter is greater than the threshold; identifying a restriction for the frequency resource for the frequency multiplexed sidelink communication based at least in part on the distance parameter being greater than the threshold; and allocating the frequency resource for the frequency multiplexed sidelink communication based at least in part on the restriction.

Aspect 21: The method of aspect 20, wherein allocating the frequency resource comprises: allocating, based at least in part on the restriction, the frequency resource for the frequency multiplexed sidelink communication within a second time window different than the time window.

Aspect 22: The method of aspect 20, wherein allocating the frequency resource comprises: allocating, based at least in part on the restriction, the frequency resource for the frequency multiplexed sidelink communication within the time window and offset in frequency from the communication resource allocated to the second UE.

Aspect 23: The method of aspect 22, further comprising: communicating configuration signaling indicating the offset in frequency.

Aspect 24: The method of any of aspects 18 through 23, wherein identifying the distance parameter comprises: determining the distance parameter based at least in part on receiving an indication, from the first UE, of an RSRP of the second UE, wherein the distance parameter and the threshold comprise respective RSRPs.

Aspect 25: The method of aspect 24, further comprising: transmitting, to the first UE and the second UE, an indication to report a measurement of an RSRP for determining the distance parameter.

Aspect 26: The method of any of aspects 24 through 25, wherein a plurality of UEs comprising the second UE are allocated respective communication resources within the time window; and the second UE has a smallest RSRP relative to the first UE out of the plurality of UEs.

Aspect 27: The method of any of aspects 18 through 23, wherein identifying the distance parameter comprises: determining the distance parameter based at least in part on receiving an indication of a location of the first UE and an indication of a location of the second UE, wherein the distance parameter and the threshold comprise respective distances.

Aspect 28: The method of aspect 27, further comprising: transmitting, to the first UE and the second UE, an indication to report a measurement of a location for determining the distance parameter.

Aspect 29: The method of any of aspects 27 through 28, wherein a plurality of UEs comprising the second UE are allocated respective communication resources within the time window; and the second UE has a largest distance from the first UE out of the plurality of UEs.

Aspect 30: The method of any of aspects 18 through 29, wherein a plurality of UEs comprising the second UE are allocated respective communication resources within the time window; and the second UE initiates a COT used by the first UE and the second UE.

Aspect 31: The method of any of aspects 18 through 30, wherein identifying the distance parameter comprises: receiving the distance parameter from the first UE based at least in part on a location or an RSRP of the second UE determined by the first UE.

Aspect 32: An apparatus for wireless communications at a first UE, comprising a processor; memory coupled with the processor; and instructions stored in the memory and executable by the processor to cause the apparatus to perform a method of any of aspects 1 through 17.

Aspect 33: An apparatus for wireless communications at a first UE, comprising at least one means for performing a method of any of aspects 1 through 17.

Aspect 34: A non-transitory computer-readable medium storing code for wireless communications at a first UE, the code comprising instructions executable by a processor to perform a method of any of aspects 1 through 17.

Aspect 35: An apparatus for wireless communications at a base station, comprising a processor; memory coupled with the processor; and instructions stored in the memory and executable by the processor to cause the apparatus to perform a method of any of aspects 18 through 31.

Aspect 36: An apparatus for wireless communications at a base station, comprising at least one means for performing a method of any of aspects 18 through 31.

Aspect 37: A non-transitory computer-readable medium storing code for wireless communications at a base station, the code comprising instructions executable by a processor to perform a method of any of aspects 18 through 31.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special purpose computer. By way of example, and not limitation, non-transitory computer-readable media may include random RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communications at a first user equipment (UE), comprising:
identifying a distance parameter associated with the first UE and a second UE;
determining whether the distance parameter is less than a threshold;
performing, within a time window that includes a communication resource allocated to the second UE and based at least in part on determining whether the distance parameter is less than the threshold, a selection process for a frequency resource for a frequency multiplexed sidelink communication; and
transmitting the frequency multiplexed sidelink communication based at least in part on the selection process.

2. The method of claim 1, further comprising:
determining that the distance parameter is less than the threshold; and
selecting the frequency resource for the frequency multiplexed sidelink communication within the time window based at least in part on the distance parameter being less than the threshold.

3. The method of claim 1, further comprising:
determining that the distance parameter is greater than the threshold;
identifying a restriction for the frequency resource for the frequency multiplexed sidelink communication based at least in part on the distance parameter being greater than the threshold; and
selecting the frequency resource for the frequency multiplexed sidelink communication based at least in part on the restriction.

4. The method of claim 3, wherein selecting the frequency resource comprises:
excluding, based at least in part on the restriction, frequency resources within the time window from candidate resources for selecting the frequency resource.

5. The method of claim 3, wherein selecting the frequency resource comprises:
selecting, based at least in part on the restriction, the frequency resource for the frequency multiplexed sidelink communication within the time window and offset in frequency from the communication resource allocated to the second UE.

6. The method of claim 1, wherein identifying the distance parameter comprises:
determining the distance parameter based at least in part on measuring a reference signal received power from the second UE, wherein the distance parameter and the threshold comprise respective reference signal received powers.

7. The method of claim 6, wherein:
a plurality of UEs comprising the second UE are allocated respective communication resources within the time window; and
the second UE has a smallest reference signal received power relative to the first UE out of the plurality of UEs.

8. The method of claim 1, wherein identifying the distance parameter comprises:
determining the distance parameter based at least in part on a location of the first UE and an indication of a location of the second UE, wherein the distance parameter and the threshold comprise respective distances.

9. The method of claim 8, wherein:
a plurality of UEs comprising the second UE are allocated respective communication resources within the time window; and
the second UE has a largest distance from the first UE out of the plurality of UEs.

10. The method of claim 1, wherein:
a plurality of UEs comprising the second UE are allocated respective communication resources within the time window; and
the second UE initiates a channel occupancy time used by the first UE and the second UE.

11. The method of claim 1, wherein identifying the distance parameter comprises:
determining the distance parameter based at least in part on a location of the first UE and a location of a channel occupancy time used by the second UE, wherein the distance parameter and the threshold comprise respective distances.

12. The method of claim 11, wherein the location of the channel occupancy time comprises a location of a wireless device that initiates the channel occupancy time.

13. The method of claim 11, wherein determining whether the distance parameter is less than the threshold comprises:
determining that the distance parameter is less than the threshold based at least in part on a zone identifier associated with the first UE being a same zone identifier associated with the channel occupancy time, wherein the location of the channel occupancy time comprises a geographic location or geographic zone associated with the channel occupancy time.

14. The method of claim 11, wherein the location of the channel occupancy time is received via channel occupancy time sharing information or is configured for the channel occupancy time.

15. A method for wireless communications at a base station, comprising:
identifying a distance parameter associated with a first user equipment (UE) and a second UE;
determining whether the distance parameter is less than a threshold;
performing, within a time window that comprises a communication associated with the second UE and based at least in part on determining whether the distance parameter is less than the threshold, a selection process for a frequency resource for a frequency multiplexed sidelink communication for the first UE; and
allocating resources to the first UE for the frequency multiplexed sidelink communication based at least in part on the selection process.

16. The method of claim 15, further comprising:
determining that the distance parameter is less than the threshold; and
allocating the frequency resource for the frequency multiplexed sidelink communication within the time window based at least in part on the distance parameter being less than the threshold.

17. The method of claim 15, further comprising:
determining that the distance parameter is greater than the threshold;
identifying a restriction for the frequency resource for the frequency multiplexed sidelink communication based at least in part on the distance parameter being greater than the threshold; and
allocating the frequency resource for the frequency multiplexed sidelink communication based at least in part on the restriction.

18. The method of claim 17, wherein allocating the frequency resource comprises:
allocating, based at least in part on the restriction, the frequency resource for the frequency multiplexed sidelink communication within a second time window different than the time window.

19. The method of claim 17, wherein allocating the frequency resource comprises:
allocating, based at least in part on the restriction, the frequency resource for the frequency multiplexed sidelink communication within the time window and offset in frequency from a communication resource allocated to the second UE.

20. The method of claim 15, wherein identifying the distance parameter comprises:
determining the distance parameter based at least in part on receiving an indication, from the first UE, of a reference signal received power of the second UE, wherein the distance parameter and the threshold comprise respective reference signal received powers.

21. The method of claim 15, wherein identifying the distance parameter comprises:
determining the distance parameter based at least in part on receiving an indication of a location of the first UE and an indication of a location of the second UE, wherein the distance parameter and the threshold comprise respective distances.

22. An apparatus for wireless communications at a first user equipment (UE), comprising:
a processor;
memory coupled with the processor; and
instructions stored in the memory and executable by the processor to cause the apparatus to:
identify a distance parameter associated with the first UE and a second UE;
determine whether the distance parameter is less than a threshold;
perform, within a time window that includes a communication resource allocated to the second UE and based at least in part on determining whether the distance parameter is less than the threshold, a selection process for a frequency resource for a frequency multiplexed sidelink communication; and
transmit the frequency multiplexed sidelink communication based at least in part on the selection process.

23. The apparatus of claim 22, wherein the instructions are further executable by the processor to cause the apparatus to:
determine that the distance parameter is less than the threshold; and
select the frequency resource for the frequency multiplexed sidelink communication within the time window based at least in part on the distance parameter being less than the threshold.

24. The apparatus of claim 22, wherein the instructions are further executable by the processor to cause the apparatus to:
determine that the distance parameter is greater than the threshold;
identify a restriction for the frequency resource for the frequency multiplexed sidelink communication based at least in part on the distance parameter being greater than the threshold; and
select the frequency resource for the frequency multiplexed sidelink communication based at least in part on the restriction.

25. The apparatus of claim 24, wherein the instructions to select the frequency resource are executable by the processor to cause the apparatus to:
exclude, base at least in part on the restriction, frequency resources within the time window from candidate resources for selecting the frequency resource.

26. The apparatus of claim 24, wherein the instructions to select the frequency resource are executable by the processor to cause the apparatus to:
select, based at least in part on the restriction, the frequency resource for the frequency multiplexed sidelink communication within the time window and offset in frequency from the communication resource allocated to the second UE.

27. The apparatus of claim 22, wherein the instructions to identify the distance parameter are executable by the processor to cause the apparatus to:
determine the distance parameter based at least in part on measuring a reference signal received power from the second UE, wherein the distance parameter and the threshold comprise respective reference signal received powers.

28. The apparatus of claim 22, wherein the instructions to identify the distance parameter are executable by the processor to cause the apparatus to:
determine the distance parameter based at least in part on a location of the first UE and an indication of a location of the second UE, wherein the distance parameter and the threshold comprise respective distances.

29. The apparatus of claim 22, wherein the instructions to identify the distance parameter are executable by the processor to cause the apparatus to:
determine the distance parameter based at least in part on a location of the first UE and a location of a channel occupancy time used by the second UE, wherein the distance parameter and the threshold comprise respective distances.

30. An apparatus for wireless communications at a base station, comprising:
a processor;
memory coupled with the processor; and
instructions stored in the memory and executable by the processor to cause the apparatus to:
identify a distance parameter associated with a first user equipment (UE) and a second UE;
determine whether the distance parameter is less than a threshold;
perform, within a time window that comprises a communication associated with the second UE and based at least in part on determining whether the distance parameter is less than the threshold, a selection process for a frequency resource for a frequency multiplexed sidelink communication for the first UE; and
allocate resources to the first UE for the frequency multiplexed sidelink communication based at least in part on the selection process.
